(19) United States
(12) Patent Application Publication
(10) Pub. No.: US 2021/0038975 A1
(43) Pub. Date: Feb. 11, 2021

(54) CALIBRATION TO BE USED IN AN AUGMENTED REALITY METHOD AND SYSTEM

(71) Applicant: THE GOOSEBUMPS FACTORY BVBA, Kortrijk (BE)

(72) Inventors: Augustin Victor Louis GRILLET, Conde sur l'Escaut (FR); Paul Hubert Andre GEORGE, Wavrin (FR); Wim Alois VANDAMME, Gistel (BE)

(73) Assignee: THE GOOSEBUMPS FACTORY BVBA, Kortrijk (BE)

(21) Appl. No.: 16/963,929

(22) PCT Filed: Jan. 22, 2019
(86) PCT No.: PCT/EP2019/051531

§ 371 Date: Jul. 22, 2020

(30) Foreign Application Priority Data
Jan. 22, 2018 (GB) 1801031.4
Apr. 20, 2018 (EP) 18168633.8

(51) Int. Cl. A63F 13/22; A63F 13/213; A63F 13/27; A63F 13/5255; A63F 13/86; G06T 19/00

(52) U.S. Cl. CPC A63F 13/22; A63F 13/213; A63F 13/27; A63F 13/5255; A63F 2300/577; G06T 19/006; A63F 2300/1018; A63F 2300/1087; A63F 2300/6676; A63F 13/86

(57) ABSTRACT

A calibration for an AR gaming system or method so that players equipped with AR capable devices such as handheld devices can join in an augmented reality game in an area such as a lobby of premises such as a cinema, shopping mall, museum, airport hall, hotel hall, attraction park, etc. The lobby L is equipped with digital Visual equipment and optionally Audio equipment connected to a digital signage network, In particular, the lobby L is populated with one or more display devices, such as fixed format displays, for instance LC displays, tiled LC displays, LED displays, plasma displays or projector displays, displaying either monoscopic 2D or stereoscopic 3D content. These displays are used to allow onlookers to see through a window onto the virtual world of the AR game.

The present application relates to a method and system for the provision of augmented reality or mixed reality games to participants with onlookers in a lobby. It also relates to software for performing these methods.

### BACKGROUND

Augmented reality is known to the art. For instance, it is known to the art to display a virtual object and/or environment overlaid on live pictures on the screen on the live camera feed of a mobile phone or tablet computer, giving the illusion that the virtual object is part of the reality.

One of the problems is that the virtual object and/or environment is not visible or hardly visible to people not in possession of a smartphone or tablet computer, or any other augmented reality capable device.

Another problem is that augmented reality requires important storage space and rendering resources from mobile devices for truly immersive experiences.

Improvement of the art is needed to make augmented reality more inclusive and less storage space and power hungry.

There are various situations in which persons have to spend time in a waiting area such as at airports, bus stations, shopping malls, museums, cinema Lobbies, entertainment centers, etc. In such waiting areas displays can be used to show a number of advertisements which repeat over and over again. Hence, there is a need to make use of existing displays in a more entertaining manner.

### SUMMARY OF THE INVENTION

In one aspect the present invention provides a hybrid or mixed augmented reality system for playing a hybrid or augmented reality game at a venue comprising at least a first display, and at least one AR capable device having a second display associated with an image sensor, the AR capable device running a gaming application, wherein display of images on the second display depends on a relative position and orientation of the AR capable device with respect to both the at least first display and virtual objects. The first display can be a non-AR device. The gaming application can feature virtual objects.

It is an advantage of that aspect of the invention that it allows onlookers also known as social spectators to see virtual objects that would otherwise only be visible to individuals in possession of an AR capable device. It is another advantage of that aspect of the invention that rendering virtual objects on a display other than the display of an AR capable device will increase the power autonomy of the AR capable device. Indeed, rendering of virtual objects is computationally intensive, thereby causing a lot of power dissipation, in particular if rendering must be done rapidly as is required for a (hybrid) mixed or augmented reality game.

In another aspect of the invention, a virtual camera (1400), e.g. within the gaming application, captures images of virtual objects for display on the first display device (34).

It is an advantage of that aspect of the invention that it will simplify the generation of images for display on the first display. By positioning a virtual camera in a 3D model of the venue where the (hybrid) mixed or augmented reality game is played, the designer of the game must not figure out how to transform the images generated to make them compatible with a given point of view in the venue.

In a further aspect of the invention, the frustum of the virtual camera is determined by the pinhole (PH) of the virtual camera and the border of the display area of the first display in the 3D model. This further simplifies the generation of images to be displayed on the first display. The position of the pinhole of the virtual camera may be determined according to the sweet spot of the AR gaming experience.

In yet a further aspect of the invention, the near clipping plane of the viewing frustum is coplanar with the surface of the 3D model of the first display corresponding to the display surface of the first display or to the display surface of the first display in the 3D model. This further simplifies the generation of images to be displayed on the first display.

In addition, it may simplify the rules to apply to decide on which of the first display device or the second display device to render a virtual object.

The system can be adapted so that images of the game content are rendered on the second display or the first display according to the pose of the AR capable device 30 within a 3D space. For example the system may include a server (33) wherein game instructions are sent back and forth between the server (33) and the at least one AR capable device (30) as part of a mixed or augmented reality game, all the 3D models of virtual objects (50, 100 . . . ) being present in an application running on the game server connected to the at least one first display (34) and the at least one AR capable devices (30) and images of the game content are rendered on the second display or the first display according to the pose of the AR capable device 30 within a 3D space. Images of a virtual object need not be rendered on the second display if said virtual object, or part of it, is within the non-visibility virtual volume of a first display.

There can be virtual objects (50, 100 . . . ) in the augmented reality game and the first display (34) can display a virtual object when the virtual object is in a viewing frustum (1403) of a virtual camera (1400).

Images of the venue and persons playing the game as well as images of a 3D model of the venue and virtual objects can be displayed on a third display. Also, images of the venue and persons playing the game as well as images of virtual object and or a model of the venue can be displayed on a third display. The 3D model of the venue includes a model of the first display and in particular, it includes information on the position of the display surface of the first display device.

An image sensor (32) can be directed towards the first display (34) displaying a virtual object, the virtual object is not rendered on the AR capable device (30) but is visible on the second display as part of an image captured by the image sensor (32).

The first display can be used to display images of virtual objects thereby allowing onlookers in the venue to see virtual objects even though they do not have access to an AR capable device.

In the game there are virtual objects and the first display displays a virtual object when for instance the virtual object is in a viewing frustum defined by the field of view of a virtual camera in the 3D model. The viewing frustum can for instance be further defined by a clipping plane of which the position and orientation are the same as the position and orientation of the display surface of the first display device in the 3D model.

A 2D representation of a 3D scene inside the viewing frustum can be generated by a perspective projection of the points in the viewing frustum onto an image plane. The image plane for projection can be the near clipping plane of the viewing frustum.

When an image sensor of the AR capable device is directed towards the first display, it can be advantageous to display images of virtual objects on the first display rather than on the second display, this not only allows onlookers to see virtual objects, it also reduce the power dissipated for rendering the 3D objects on the AR capable device. Furthermore, it increases the immersiveness of the game for player equipped with AR capable device.

Another aspect of the invention provides a method of playing a mixed or augmented reality game at a venue comprising at least a first display (34), and at least one AR capable device (30) having a second display associated with an image sensor (32), the method comprising:

running a gaming application on the at least one AR capable device, the method being characterized in that the images of virtual objects displayed on the second display are function of a relative position and orientation of the AR capable device with respect to both the first display and the virtual objects.

In a further aspect of the invention, the method further comprises the step of generating images for display on the first display by means of a 3D camera in a 3D model of the venue.

In a further aspect of the invention, the display device on which a virtual object is rendered depends on the position of a virtual object with respect to the virtual camera.

In particular, a virtual object is rendered on the first display if the virtual object is within a viewing frustum of the virtual camera. In that case, the computational steps to render that 3D object are not carried out on an AR capable device but on another processor like e.g. the server thereby increasing the power autonomy of the AR capable device.

Objects not rendered by a handheld device can nevertheless be visible on that AR capable device through image capture by the camera of the AR capable device when the first display is in the viewing cone of the camera.

In a further aspect of the invention, a virtual object that is being rendered on the first display device can nevertheless be rendered on an AR capable device if the display surface is not in the viewing cone of the camera of that AR capable device and the virtual object is in the viewing cone of the camera of that AR capable device.

In another aspect of the present invention a mixed or augmented reality system for playing a mixed or augmented reality game at a lobby is disclosed comprising at least a first display (34), and at least one AR capable device (30) having a second display (31), the AR capable device running a gaming application, further comprising a calibration wherein a predetermined pose or reference pose within the lobby is provided to compare the position and/or the pose of the AR capable device with that of other objects or a position or pose of an AR capable device is determined by analysis of images taken by a camera with pose data from an AR capable device. By using a reference within the lobby which is the area where the game is played, it is easy for the players to calibrate their position.

The calibration can comprise positioning the AR capable device at a known distance from a distinctive pattern. Again it is easy to use a reference with a distinctive pattern. For example the known distance can be an extremity of a measuring device extending from a first reference position at which the pattern is displayed.

The calibration preferably includes the AR capable device being positioned so that an image of the distinctive pattern is more or less centered on a display area of the AR capable device, i.e. the image appears visibly in the display area of the AR capable device. This is easy for a player to determine the correctness of the position of the image. Preferably when the AR capable device is positioned, the pose data is validated. The validation can be automatic, direct or indirect. For example, the player can validate pose data by a user action e.g. pressing a key of the AR capable device or by touching the touchscreen at a position indicated on the touchscreen by the application. Once validated, the pose data associated with a first reference point in the lobby can be stored on the AR capable device or is sent to a server together with an identifier to associate that data to the particular AR capable device. Optionally a second reference point different from the first reference point or a plurality of such reference points can be used. This improves the accuracy of the calibration. The AR capable device can be a hand held device such as a mobile phone.

The present invention also includes a method of operating a mixed or augmented reality system for playing a mixed or augmented reality game at a lobby comprising at least a first display (34), and at least one AR capable device (30) having a second display (31), the method comprising calibrating the position and/or the pose of the AR capable device with that of other objects by comparing the pose of the AR capable device with a predetermined pose or reference pose within the lobby. The calibrating can comprise positioning the AR capable device at a known distance of a distinctive pattern. The known distance can be an extremity of a measuring device extending from a first reference position at which the pattern is displayed. The calibrating can include the AR capable device being positioned so that an image of the distinctive pattern is more or less centered on a display area of the AR capable device, i.e. that the image appears in the display area of the AR capable device. Preferably, when the AR capable device is positioned, the pose data is validated. The validation can be automatic, direct or indirect. For example, the player can validate pose data by a user action e.g. pressing a key of the AR capable device or by touching the touchscreen at a position indicated on the touchscreen by the application. Once validated, the pose data associated with a first reference point in the lobby can be stored on the AR capable device or can be sent to a server together with an identifier to associate that data to the particular AR capable device. A second reference point different from the first reference point or a plurality of such reference points can be used.

The present invention also includes software which may be implemented as a computer program product which executes any of the method steps of the present invention when compiled for a processing engine in any of the servers or nodes of the network of embodiments of the present invention.

The computer program product may be stored on a non-transitory signal storage medium such as an optical disk (CD-ROM or DVD-ROM), a digital magnetic tape, a magnetic disk, a solid state memory such as a USB flash memory, a ROM, etc.

### BRIEF DESCRIPTION OF THE FIGURES

FIG. 1 shows an example of handheld device that can be used with embodiments of the present invention.

FIG. 2 shows a perspective view of handheld device and illustrate the field of view of a camera associated with the handheld device for use with embodiments of the present invention.

FIG. 3 shows an example of augmented reality set-up according to an embodiment of the present invention.

FIG. 4 shows an example illustrates how to calibrate the pose sensor of the handheld device according to an embodiment of the present invention.

FIG. 5 illustrates what is displayed on display device and on an AR capable device such as a handheld device in augmented reality as known to the art.

FIG. 6 illustrates what is displayed on display device 34 and an AR capable device such as a handheld device 30 according to embodiments of the present invention.

FIG. 7 shows how an AR capable device 30 undergoes a translation T and is pressed on the displayed footprint at the end of the translation according to an embodiment of the present invention.

FIG. 8 shows how a background such as a tree 52 is displayed on a display even though the position of a dragon is such that it is only visible to player P on the AR capable device according to an embodiment of the present invention.

FIG. 9 shows an image of the lobby L taken by a camera 200 showing a display device, a display device displaying a footprint and a modus operandi and an AR capable device held by player P according to an embodiment of the present invention.

FIG. 10 shows a rendering of a 3D model of the lobby L together with virtual objects like to dragon and a tree according to an embodiment of the present invention.

FIG. 11 shows a mixed reality image of the picture illustrated on FIG. 9 and the rendering of the 3D model illustrated on FIG. 10.

FIG. 12 shows the lobby with the display device displaying the mixed reality image according to an embodiment of the present invention.

FIG. 13 shows the pose of an AR capable device being such that the display is out of the field of view of the camera on the AR capable device according to an embodiment of the present invention.

FIG. 14 shows a particular moment in a game as it can be represented in the 3D model of the lobby according to an embodiment of the present invention.

FIG. 15 shows a situation where a virtual object is outside of the viewing frustum so that a rendering of the virtual object is not displayed on the display according to an embodiment of the present invention.

FIG. 16 shows how a border of the display area of the 3D model of a display 34 can be a directrix of the viewing cone according to an embodiment of the present invention.

FIG. 17 shows an intermediary case where part of a virtual object is in the viewing frustum and part of the virtual object is outside of the frustum according to an embodiment of the present invention.

FIGS. 18, 19, 20 and 21 illustrate different configurations for a first display device 34, a virtual object 50, a handheld display 30 and its associated camera 32.

FIG. 22 shows a process to build a game experience in a lobby according to embodiments of the present invention.

FIG. 23 shows the physical architecture of the lobby in which the game according to embodiments of the present invention is played.

FIG. 24 shows the network data flow in the lobby in which the game according to embodiments of the present invention is played.

FIG. 25 shows a calibration procedure according to embodiments of the present invention.

FIG. 26 shows an arrangement for a further calibration procedure according to embodiments of the present invention.

FIGS. 27 and 28 show methods of setting up a lobby and a 3D model for playing a game according to embodiments of the present invention.

FIG. 29 shows a fixed display with a virtual volume according to an embodiment of the present invention.

### DEFINITIONS AND ACRONYMS

“Mixed or hybrid augmented reality system or algorithm”. The terms “Mixed reality” and “hybrid augmented reality” are synonymous in this application. Mixed reality or hybrid augmented reality, is the merging of real and virtual augmented worlds to produce new environments and visualizations where physical and digital objects co-exist and interact in real time. The following definitions indicate the differences between virtual reality, mixed reality and augmented reality:

Virtual reality (VR) immerses users in a fully artificial digital environment.

Augmented reality (AR) overlays virtual objects on the real-world environment.

Mixed reality (MR) not just overlays but anchors virtual objects to the real world and allows the user to interact with the virtual objects.

3D Model. 3D Model. Three-dimensional (3D) models represent a physical body using a collection of points in 3D space, connected by various geometric entities such as triangles, lines, curved surfaces, etc. Being a collection of data (points and other information), 3D models can be created by hand, algorithmically (procedural modeling), or scanned. The architectural 3D model of the venue can be captured from a 3D scanning device or camera or from a multitude of 2D pictures, or created by manual operation using a CAD software.

Their surfaces may be further defined with texture mapping.

Editor. A computer program that permits the user to create or modify data (such as text or graphics) especially on a display screen.

Field Of View. The field of view is the extent of the observable world that is seen at any given moment. In the case of optical instruments or sensors it is a solid angle through which a detector is sensitive to electromagnetic radiation.

The field of view is that part of the world that is visible through a camera at a particular position and orientation in space; objects outside the FOV when the picture is taken are not recorded in the photograph. It is most often expressed as the angular size of the view cone.

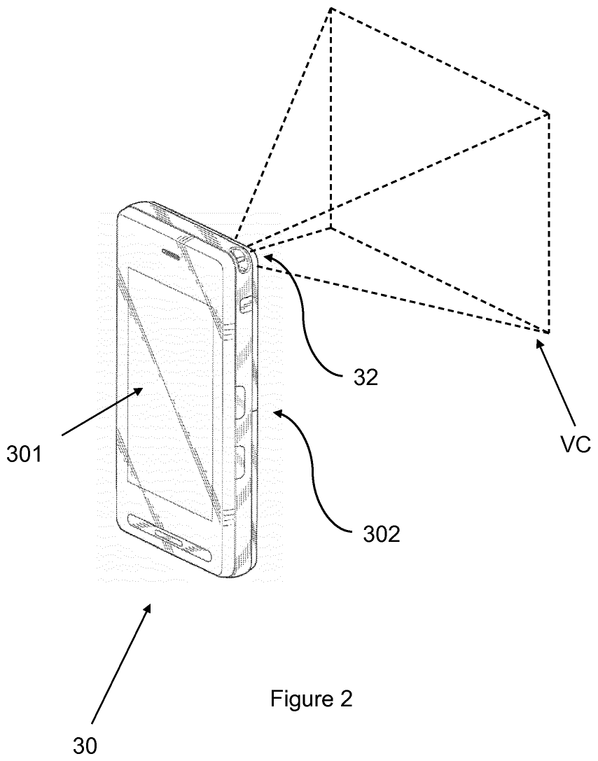

The view cone VC of an image sensor or a camera 32 of a handheld device 30 is illustrated on FIG. 2.

The solid angle, through which a detector element (in particular a pixel sensor of a camera) is sensitive to electromagnetic radiation at any one time, is called Instantaneous Field of View or IFOV.

FOV. Acronym for Field Of View.

An AR capable device portable electronic device for watching image data including not only smartphones and tablets, but also head mounted devices like AR glasses such as Google Glass or, ODG R8 or Vuzix glasses or transparent displays like transparent OLED displays. The spatial registration of an AR capable device within the architectural 3D model of the venue can be achieved by recognition and geometric registration algorithm of a pre-defined pattern or of a physical reference point present in the venue and spatially registered in the architectural 3D model of the venue, or by any other technique known to the state of the art for AR applications. A registration pattern may be displayed by the game computer program on one first display with the pixel coordinates of the pattern being defined in the game computer program. There may be a multitude of different registration patterns displayed on the multitude of first displays, the pixel coordinates of each pattern, respectively, being defined in the game computer program. The spatial registration of the at least one AR capable device may be achieved and/or further refined by image analysis of the images captured by the one or multiple cameras present in the venue where said AR capable device is being operated.

Handheld Display. A portable electronic device for watching image data like e.g. video images. Smartphones and tablet computers are examples of handheld displays.

Mobile Application or Application. A mobile application is a computer program designed to run on a mobile device such as a phone/tablet or watch, or head mounted device.

Mesh of a three dimensional (3D) model can be associated to specific properties. An occlusion mesh is a three-dimensional (3D) model representing a volume which will be used for producing occlusions in an AR rendering, meaning virtual objects can be hidden by a physical object. Parts of 3D virtual objects hidden in or by the occlusion mesh are not rendered. A collision mesh is a three-dimensional (3D) model representing physical nonmoving parts (walls, floor, furniture etc.) which will be used for physics calculation. A Nay (or navigation) mesh is a three-dimensional (3D) model representing the admissible area or volume and used for defining the limits of the pathfinding for virtual agents.

Pose. In augmented reality terminology, the pose designates the position and orientation of a rigid body. The pose of e.g. a handheld display can be determined by the Cartesian coordinates (x, y, z) of a point of reference of the handheld display and three angles, e.g. the Euler angles, (α, β, γ). The rigid body can be real or virtual (like e.g. a virtual camera).

Rendering or image synthesis is the automatic process of generating a photorealistic or non-photorealistic image from a 2D or 3D model (or models in what collectively could be called a scene file) by means of computer programs. Also, the results of displaying such a model can be called a render.

Virtual Camera. A virtual camera is used to generate a 2D representation of a view of a 3D model. A virtual camera is modeled as a frustum. The volume inside the frustum is what the virtual camera can see. The 2D representation of the 3D scene inside the viewing frustum can e.g. be generated by a perspective projection of the points in the viewing frustum onto an image plane (like e.g. one of the clipping plane and in particular the near clipping plane of the frustum). Virtual cameras are known from editors like Unity.

Virtual Object. Object that exists as a 3D model. Visualization of the 3D object requires a display (including a 2D and a 3D print-out).

Wireless router. A device that performs the functions of a router and also includes the functions of a wireless access point. It is used to provide access to the Internet or a private computer network. Depending on the manufacturer and model, it can function in a wired local area network, in a wireless-only LAN, or in a mixed wired and wireless network. Also, 4G/5G mobile networks can be included although there may be latency for 4G that could lead to latency between visual content on the display devices and the handheld device.

A virtual volume is a volume which can be programmed in a game application as either a visibility volume or a non-visibility volume with respect a given virtual object, for the AR capable device such as a handheld AR device 30. “Visibility” and “non-visibility” means in this context whether a given virtual object is visible or not visible on the display of the AR capable device such as the handheld device 30.

### DESCRIPTION OF ILLUSTRATIVE EMBODIMENTS

The present invention relates to a mixed (hybrid) or augmented reality game that can be played within the confines of a lobby or hall or other place where persons are likely to wait. It improves the entertainment value for onlookers who are not players by a display being provided which acts like a window on the virtual world of the (hybrid) mixed or augmented reality game. In addition a mixed reality display can be provided which gives an overview of both the real space where the persons are waiting and the virtual world of the augmented reality game. The view of the real space can be a panoramic image of the waiting space. US 2017/293459 and US 2017/269713 disclose a second screen providing a view into a virtual reality environment and are incorporated herein by reference in their entirety.

In a first example of embodiment, players, like P, equipped with AR capable devices such as handheld devices 30 can join in a (hybrid) mixed or augmented reality game in an area such as a lobby L of premises such as a cinema, shopping mall, museum, airport hall, hotel hall, attraction park, etc.

The lobby L is equipped with digital Visual equipment and optionally Audio equipment connected to a digital signage network, as commonly is the case in professional venues such as Shopping Malls, Museums, Cinema Lobbies, Entertainment Centers, etc. In particular, the lobby L is populated with one or more display devices, such as fixed format displays, for instance LC displays, tiled LC displays, LED displays, plasma displays or projector displays, displaying either monoscopic 2D or stereoscopic 3D content.

An AR capable device such as handheld device 30 can be e.g. a smartphone, a tablet computer, goggles etc. The AR capable devices such as handheld devices 30 have a display area 31, an image sensor or a camera 32 and the necessary hardware and software to support a wireless connection such as a Wi-Fi data communication, or mobile data communication of cellular networks, such as 4G/5G.

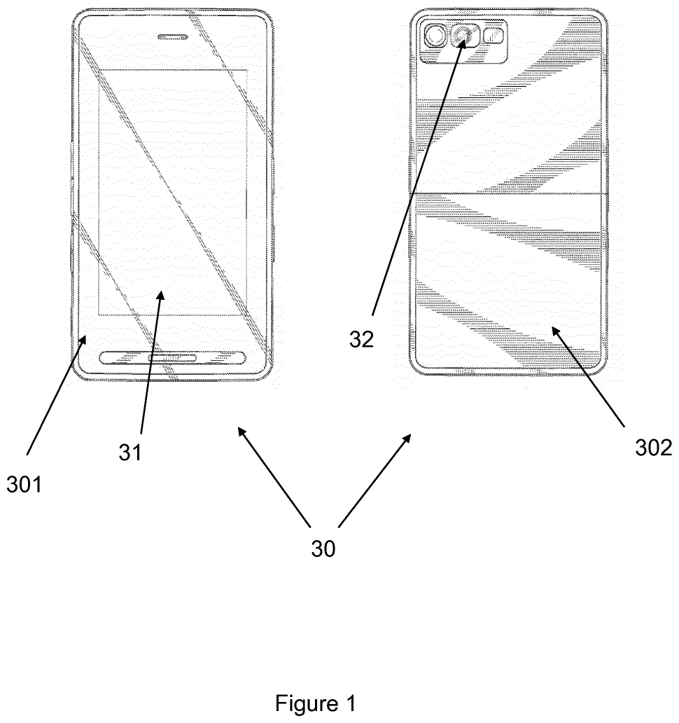

For the sake of clarity, it is assumed that the display area 31 and the image sensor or camera 32 of the AR capable device such as the handheld device 30 are positioned as in the example in FIG. 1. FIG. 1 shows a mixed or augmented reality system for providing a mixed or augmented reality experience at a venue having an AR capable device such as a handheld device 30.

The AR capable device such as the handheld device has a first main surface 301 and a second main surface 302. The first and second main surfaces can be parallel to each other. The display area 31 of the AR capable device such as the handheld device 30 is on the first main surface 301 of the handheld device and the image sensor or camera 32 is positioned on the second main surface 302 of the AR capable device such as the handheld device 30. This configuration ensures that the camera is pointing away from the player P when the player looks directly at the display area.

The AR capable devices such as handheld devices 30 can participate in an augmented reality game within a augmented game area located in the lobby L. Embodiments of the present invention provide an augmented reality gaming environment in which AR capable devices such as handheld devices 30 can participate, also a display is provided which can display virtual objects for onlookers sometimes known as social spectators, as well as a mixed reality view for the onlookers, which view provides an overview of both the lobby (e.g. a panoramic view thereof) and what is in it as well as the augmented reality game superimposed on the real images of the lobby. An architectural 3D model, i.e. a 3D model of the venue is provided or obtained. The 3D architectural model of the venue can be augmented and populated with virtual objects in a gaming computer program. There are at least one first display 34, and the at least one AR capable device such as the handheld device 30 having a second display 301 associated with an image sensor 3. The gaming computer program can contain virtual objects being augmented with the 3D architectural model of the venue, or elements from it. The 3D architectural model of the venue can only consist in the 3D model of the first display 34.

Display of images on any of the first and second displays depends on their respective position and orientation within the architectural 3D model of the venue. The position and orientation of the at least one first display 34 are fixed in space and accordingly represented within the 3D model of the venue. The position and orientation of the at least one AR capable device such as the handheld device 30 are not fixed in space. The position and orientation of the at least one AR capable device are being updated in real time within the 3D model with respect to its position and orientation in the real space.

The spatial registration of an AR capable device such as the handheld device 30 within the architectural 3D model of the venue can be achieved by recognition and geometric registration algorithm of a pre-defined pattern or of a physical reference point present in the venue and spatially registered in the architectural 3D model of the venue, or by any other technique known to the state of the art for AR applications. A registration pattern may be displayed by the gaming computer program on one first display 34 with the pixel coordinates of the pattern being defined in the gaming computer program. There may be a multitude of different registration patterns displayed on the multitude of first displays, the pixel coordinates of each pattern, respectively, being defined in the gaming computer program. The spatial registration of the at least one AR capable device such as the handheld device 30 may be achieved and/or further refined by image analysis of the images captured by the one or multiple cameras present in the venue where said AR capable device is being operated.

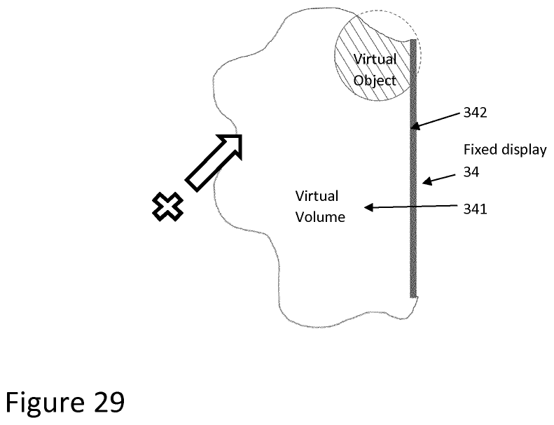

A server 33 generates data such as image data, sound data etc. . . . . In particular, the server 33 sends image data to the first display device 34. The display device 34 can be for instance a fixed format display such as a tiled LC display, a LED display, or a plasma display or it can be a projector display, i.e. forms a projected image onto a screen either from the front or the back thereof. The at least one first display 34 can be a non-AR capable display. As shown schematically in FIG. 29, each fixed display device such as first display device 34 may be further characterised by a virtual volume 341 in front of or behind the fixed display 34 having one side coplanar with its display surface 342. A virtual volume 341 may be programmed in the game application as either a visibility volume or a non-visibility volume with respect to a given virtual object, for the AR capable device such as the handheld device 30.

The data can be sent from the server 33 to the first display device 34 via any suitable device or protocol such as DVI, Display Port or HDMI cables, with or without Ethernet optical fibre extenders 35, or via a streamed internet protocol over a LAN network. The image data can be converted as required, e.g. by the HDMI-Ethernet converter, or decoded by an embedded media player before being fed to the display 34.

The server 33 is not limited to generating and sending visual content to only one display device 34, but can address a multitude of display devices present in the lobby L, within the computing, rendering and memory bandwidth limits of its central and/or graphical processor(s). Each of the plurality of displays may be associated with a specific location in the augmented reality game. These displays allow onlookers to view a part of the augmented reality game when characters in the game enter a specific part of the virtual world in which the augmented reality game is played.

A router such as a wireless router, e.g. Wi-Fi router 36 can be configured to relay messages from the server 33 to the AR capable devices such as handheld devices 30 and vice versa. Thus, the server may send gaming instructions back and forth with the AR capable devices such as the handheld devices 30. Images and optionally sound will be generated on the AR capable devices such as handheld devices 30 in order for these devices to navigate through the augmented reality game and gaming environment.

A 3D model 37 of the lobby L is available to the server 33. For instance, the 3D model 37 of the lobby L is available as a file 38 stored on the server 33. The 3D model 37 can be limited to a particular region 39 of the lobby for instance at and around the first display device 34, or even consist in the 3d model of the first display only.

The 3D model typically contains the coordinates of points within the lobby L. The coordinates are typically Cartesian coordinates given with respect to a known system of axes and a known origin.

In particular, the 3D model preferably contains the Cartesian coordinates of all display devices like display device 34 within the Lobby L or the region of interest 39. It also contains the pose (position and orientation) of any image sensors such as cameras. The Cartesian coordinates of a display device can for instance be the coordinates of the vertices of a parallelogram that approximate a display device.

An application 303 runs on the AR capable device such as the handheld device 30. The application 303 uses the image sensor or camera 32 and/or one or more sensors to determine the pose of the AR capable device such as the handheld device 30. The position (location in the lobby) can for instance be determined using indoor localization techniques such as described in IEEE TRANSACTIONS ON SYSTEMS, MAN, AND CYBERNETICS—PART C: APPLICATIONS AND REVIEWS, VOL. 37, NO. 6, November 2007 1067 “Survey of Wireless Indoor Positioning Techniques and Systems Hui Liu, Student Member, IEEE, Houshang Darabi, Member, IEEE, Pat Banerjee, and Jing Liu”. For example, location may be by GPS coordinates of the AR capable device such as the handheld device 30, by triangulation from wireless beacons such as Bluetooth or UWB emitters (or beacons) or more preferably by means of a visual inertial odometer or SLAM (Simultaneous Localisation and Mapping), with or without optical markers. AR capable devices such as handheld or head mounted devices can compute the position and orientation of such devices with the position and orientation monitored in real time thanks to, for example, ARKit (iOS) or ARCore (Android) capabilities.

The pose of the AR capable device such as the handheld device 30 is transmitted to the server 33 through the router, such as wireless router e.g. Wi-Fi router 36 or via a cellular network. The transmission of the position and orientation of the AR capable device such as the handheld device 30 to the server 33 can be done continuously (i.e. every time a new set of coordinates x, y, z and Euler angles is available), upon request of the server 33 or according to a pre-determined schedule (e.g. periodically) or on the initiative of the AR capable device such as the handheld device 30. Once the server knows the position and orientation of an AR capable device, it can send metadata to the AR capable device that contains information on the position of virtual objects to be displayed on the display of the AR capable device. Based on the metadata received by the server, the application running on the AR capable device determines which object(s) to display as well as how to display the objects (including the perspective, the scale etc. . . . ).

It can be advantageous to be able to compare the pose of the AR capable device such as the handheld device 30 with that of other objects, for example not only real objects, like e.g. the display 34 or other fixed elements of the lobby L (like doors, walls, etc.) or mobile real elements such as other players or spectators, but also virtual objects that exist only as 3D models.

One or more cameras taking pictures or videos of the lobby, and connected to the server 33 via any suitable cable, device or protocol, can also be used to identify onlookers in the lobby and determine their position in real time. A program running on e.g. the server can generate 3D characters for use in a rendering of the lobby as will be later described.

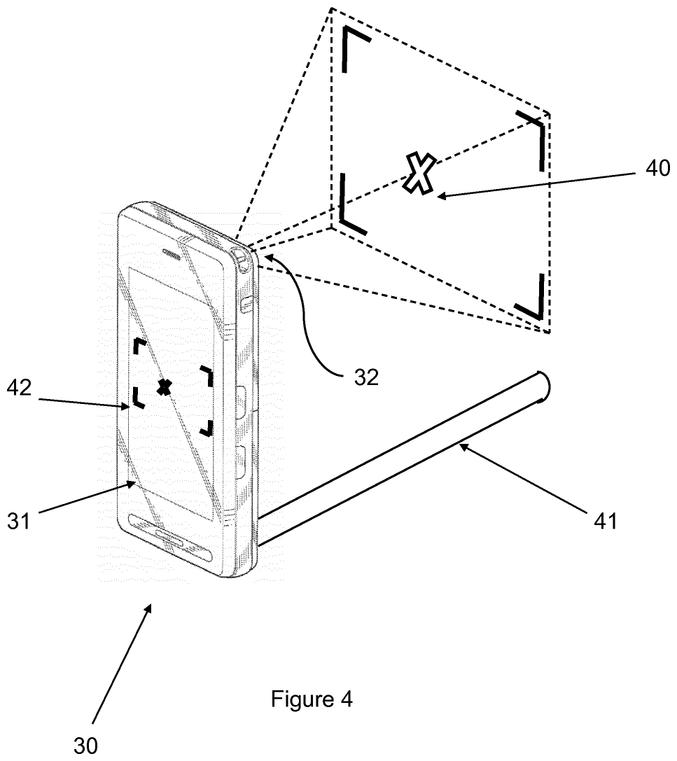

To compare the position, and more generally the pose, of the AR capable device such as the handheld device 30 with that of other objects, one can use a predetermined pose or reference pose within the lobby to calibrate the data generated by the application 303. For instance, as illustrated on FIG. 4, a player P can position the AR capable device such as the handheld device 30 at a known distance of a distinctive pattern 40. The known distance can for instance be materialized by the extremity of a measuring device such as a stick 41 extending from e.g. a wall on which the pattern is displayed. The player can further be instructed to orient the AR capable device such as the handheld device so that e.g. the image 42 of the pattern 40 is more or less centered on the display area of the AR capable device such as the handheld device 30, i.e. the image 42 appears visibly on the display of the AR capable device. Once the AR capable device such as the handheld device 30 is positioned according to instructions, the player P can validate the pose data generated by the application 303. The validation can be automatic, direct or indirect. For example, the player can validate pose data by a user action e.g. pressing a key of the AR capable device or by touching the touchscreen at a position indicated on the touchscreen by the application. Once validated, the pose data associated with a first reference point in the lobby can either be stored on the AR capable device such as the handheld device 30 or sent to the server 33 together with an identifier to associate that data to the particular AR capable device such as a handheld device 30.

With ARKit/ARCore the depth through the camera can be checked e.g. without a need for a reference distance such as a stick, but the results are sometimes not ideal, because it's looking at feature points that the user must have seen from different angles, so it's not 100% reliable and may require several tries. Accurate depth detection can be achieved with SLAM (Tango phone or Hololens).

An optical marker or AR tag can be used like the one of Vuforia with which there are less procedures, the user only has to point the camera of the AR capable device at it, which gives the pose of the tag.

The position of the pattern 40 is also known in the 3D model which gives a common reference point to the AR capable device such as the handheld device 30 in the real world and the 3D model of the lobby.

Depending on the precision required for a particular augmented reality application, it may be advantageous to use a second predetermined point of reference different from the first or a plurality of such reference points.

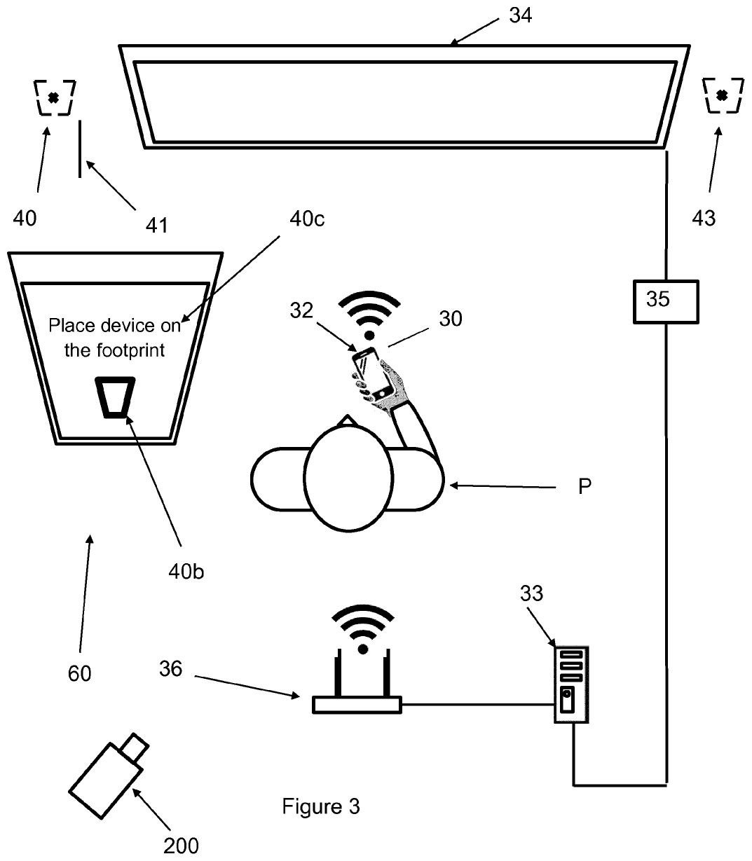

A second distinctive pattern can be used. In the example of FIG. 3, the first calibration point is identified by the first pattern 40 on one side of the display device 34 and a second calibration point is identified by the second pattern 43 on the other side of the display device 34.

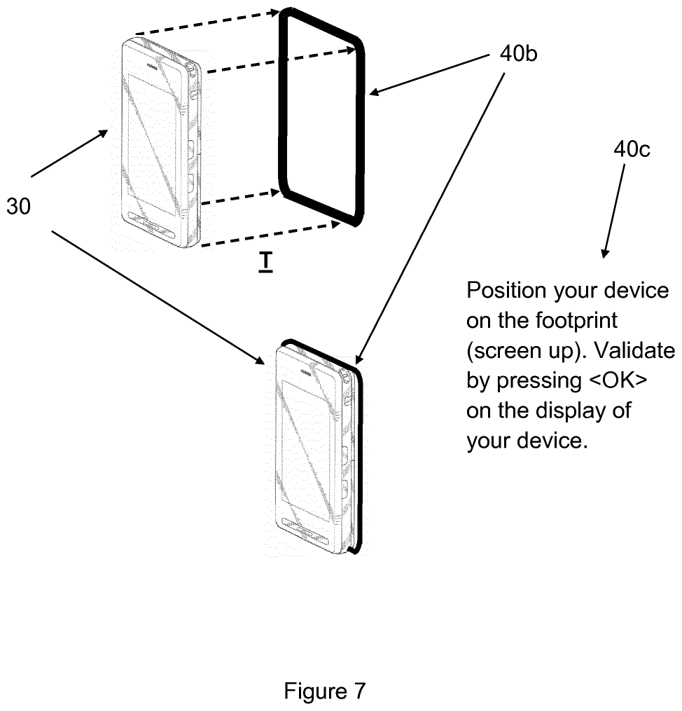

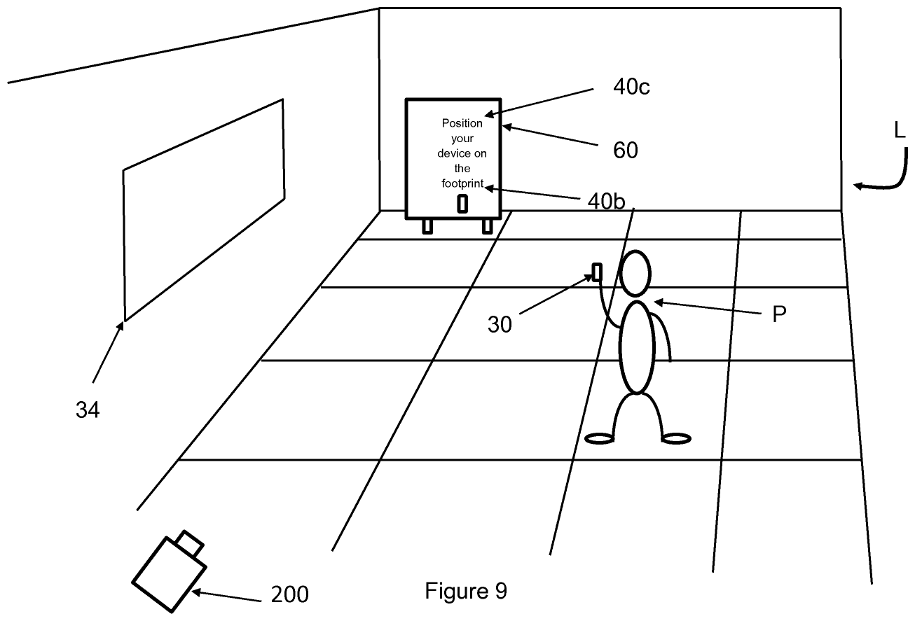

In one particular embodiment of the invention, the distinctive pattern can be displayed on a display device like e.g. the first display device 34 or a distinct display device 60 as illustrated on FIG. 3 and FIG. 9. A modus operandi 40c can be displayed at the same time as the distinctive pattern (see FIG. 9). The distinctive pattern can be e.g. a footprint 40b of a typical AR capable device such as a handheld device 30 (see FIG. 9). On FIG. 7, the device 30 undergoes a translation T and is pressed on the displayed footprint at the end of the translation.

The position of the display device 34 and/or 60 is known from the 3D model and therefore, the position of the one or more footprints is known. Hence, once the device 30 is positioned against the footprint 40b, the player P can validate the pose determined by the application running on device 30. The validation can be automatic, direct or indirect. For example, the player can validate pose data by a user action e.g. pressing a key of the AR capable device or by touching the touchscreen at a position indicated on the touchscreen by the application. As in the previous example, the pose (x₀, y₀, z₀; α₀, β₀, γ₀) is associated to an identifier and send to the server 33. The position of the display device 34 or 60 being known and the position of the footprint 40b on the display area being known, the server 33 can match the pose (x₀, y₀, z₀; α₀, β₀, γ₀) as measured on the device 30 with the a reference pose in the 3D model (in this case, the pose of the footprint 40b).

A second footprint can be displayed elsewhere on the display area of display 34 or 60 or on another display in the lobby. Depending on the calibration algorithm used, additional footprints can be displayed on the same or different display devices like 34 and 60 to increase the number of reference poses.

After the calibration phase, it is possible to make a mapping between the real world and the 3D model and determine the relative position and/or orientation between two objects like e.g. an AR capable device such as a handheld device 30 and the screen 34, an AR capable device such as a handheld device 30 and the physical environment (such as doors, walls), an AR capable device such as a handheld device 30 and another AR capable device such as another handheld device 30, or between the AR capable device such as the handheld device 30 and a virtual object.

Knowing the relative position and/or orientation of the AR capable device such as the handheld device 30 and the display device 34 with respect to both a common architectural 3D model and virtual objects is what makes it possible to solve the problem that affects augmented reality as known in the art.

Indeed, by making use of the display screen 34 as will be described, other people present in the lobby (i.e. the onlookers sometimes known as social spectators) can get an idea of what the player P is seeing and better understand the reactions of player P. The display screen 34 can be operated as if it were a window onto a part of the virtual world of the augmented reality game, a window through which onlookers can view this part of the virtual world.

Let us say that the player P is chasing a virtual dragon 50 generated by a program running on e.g. the server 33. To illustrate the difference between augmented reality as known in the art and the inclusive augmented reality according to embodiments of the present invention, let us assume that the player P is facing the display device 34 as illustrated on FIG. 3 and that the position of the virtual dragon at that moment is in front of the player P and at more or less the same height as the display area of the display device 34. In particular, at least part of the display device 34 is within the viewing cone/field of view of the image sensor or camera 32 of the AR capable device such as the handheld device 30.

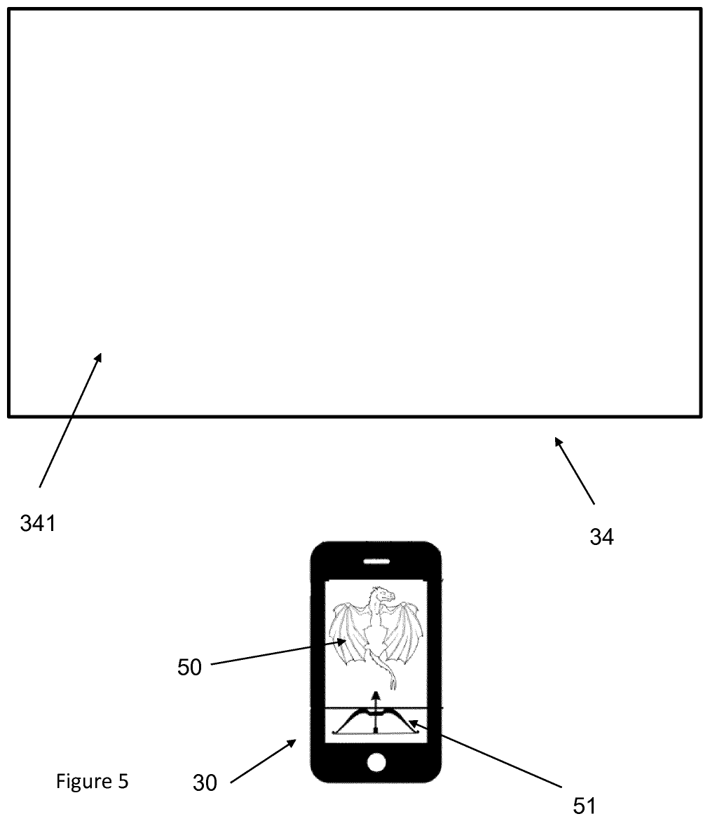

FIG. 5 illustrates what is displayed on display device 34 and on an AR capable device such as a handheld device 30 in augmented reality as known to the art. No dragon 50 is displayed on the display surface 341 of display device 34. The dragon is only visible to player P on the display area of the AR capable device such as the handheld device 30. As illustrated on FIG. 5, a bow 51 and arrow 53 are displayed on the AR capable device such as the handheld device 30.

Images of the dragon and the bow are overlaid (on the display area of the AR capable device such as the handheld device 30) on live pictures of the real world taken by the image sensor or camera 32 of the AR capable device such as the handheld device 30.

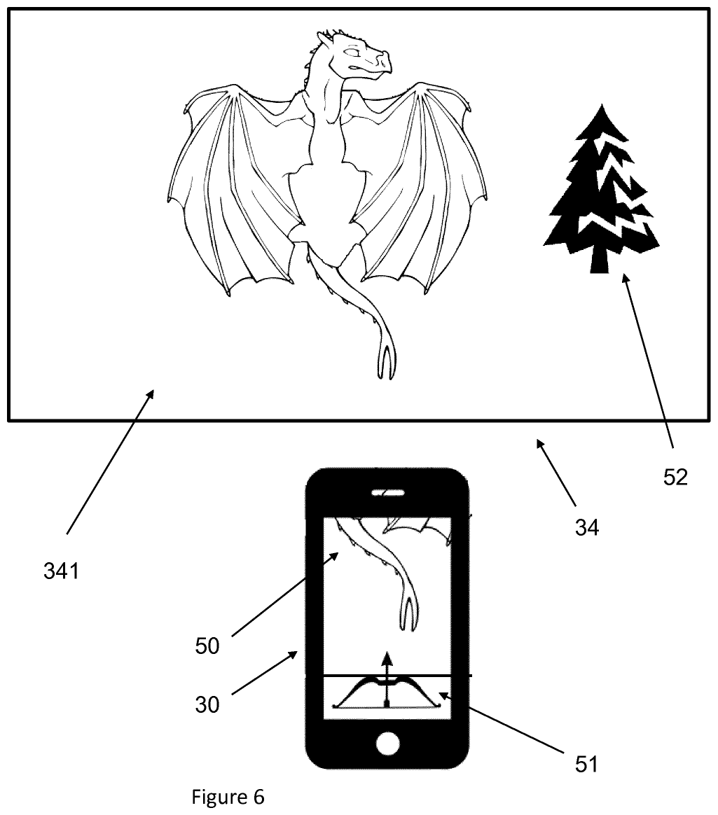

FIG. 6 illustrates what is displayed on display device 34 and an AR capable device such as a handheld device 30 according to embodiments of the present invention. Since the position of the dragon is such that it is at the height of the display area of the display device 34, a software 500 running on the server 33 can determine that the virtual dragon lies with that part of the virtual world that can be viewed through the display 34. Therefore, images of the dragon must be displayed on the display device 34. But these images are not shown on the AR capable device such as the handheld device 30. Instead the image sensor or camera 32 of the AR capable device such as the handheld device 30 captures the image of the dragon on display 34. For this purpose the images belonging to the virtual world of the augmented reality game must be suppressed on the AR capable device such as the handheld device 30. If they were not suppressed there would be a confusion between the images generated on the AR capable device such as the handheld device 30 and the images captured by the image sensor or camera 32. Thus, the present invention allows other people than the game players to see the dragon and allowing these people to understand the reactions of a player. The player P sees the images of the dragon displayed on the display device 34 as they are captured by the image sensor camera 32 and displayed on the display area of the AR capable device such as the handheld device 30. The onlookers see the dragon on the display 34 directly.

The images on the display 34 and on the display 31 of the AR capable device such as the handheld devices 30 can include common information but the display 31 can include more, e.g. weapons or tools that the AR capable device such as the handheld device 30 can use in the augmented reality game. For example, the player P can shoot an arrow 53 with the virtual bow 51 displayed on the AR capable device such as the handheld device 30, e.g. and only on such a device. If an arrow is shot (by e.g. by a user input such as pressing a button on the AR capable device such as the handheld device 30 or touching the screen of the AR capable device such as the handheld device 30), the arrow can be displayed solely on the AR capable device such as the handheld device 30 or it can be displayed on the display device 34 in function of its trajectory. If the arrow reaches the dragon, it—or its impact—can be displayed on the device 34 which will allow onlookers to see the result of player P's actions.

In general, the position and trajectory of virtual objects within the gaming computer program can be determined according to the size, pixel resolution, number, position and orientation of the first display(s) and/or other architectural features of the 3D model.

More generally, the position and trajectory of virtual objects within the gaming computer program can be determined according to the position and orientation of the at least one AR capable device such as a handheld device 30.

More generally, the position and trajectory of virtual objects within the game computer program can be determined according to the number of AR capable devices such as handheld devices 30 present in the venue and running the game application associated to the gaming computer program.

More generally, the position and trajectory of virtual objects within the gaming computer program can be determined according to the position, orientation and field of view of one or more physical camera(s) present in the venue.

During the game, the position of the dragon is changed by the software 500. The software determines whether or not to display the dragon (or another virtual object) on the display 34 according to a set of rules which determine on which display device to display a virtual object in function of the position of the virtual object in the 3D model of the lobby, i.e. within the augmented reality arena, and the 3D position of that display device 34 within the lobby in the real world.

The set of rules can be encoded as typically performed in programming of video games, or as e.g. a look-up table, a neural network, fuzzy logic, a grafcet etc. Such rules can determine whether to show a virtual object which is part of the AR game or not. For example, if a virtual object such as the dragon of the AR game is located behind the display 34 which operates as a window on the AR game for onlookers, then it can be or is shown on the display 34. If it's in the walkable space of the lobby, i.e. within the augmented reality arena but not visible through the window provided by display 34, then it can be shown solely on the AR capable device such as the handheld 30. Other examples of rules will be described.

The set of rules can also include displaying a first part of a virtual object on the display screen 34 and a second part of the virtual object on the AR capable device such as the handheld device 30 at the same time. This can for instance apply when the display device 34 is only partially in the field of view of the image sensor or camera 32 associated to the AR capable device such as the handheld device 30. Projectors or display devices 34 can also be used to show shadow of objects projected on the floor or on the walls. Users with an AR capable device would see the full picture, whereas social spectators would only see the shadow.

When the virtual object such as the dragon is in the augmented reality arena which can coincide with the lobby but not visible to onlookers (social spectators) through the display 34, a shadow of dragon could be projected on the ground at a position corresponding to that of the dragon in the air. The shadow could be projected by e.g. a gobo light as well as by a regular projector (i.e. project a halo of light with shadow in the middle). The position of the shadow (on the ground or walls) could be determined by the position of the gobo light/projector and the virtual position of the dragon. This is allowed because of the one-to-one mapping between the 3D model in which the coordinates of the dragon are determined and the venue: the controller controlling the gobo light “draws” a straight line between its position and the position of the dragon so that motors point the projector in the right direction and (in the case of a projector) the shadow is computed in function of the position of the dragon, its size and the distance to the wall/floor on which to project. This is made possible “on the fly” because the controller/server has access to a 3D model of the venue.

Summarizing the above, the server 33 sends gaming instructions back and forth with the AR capable devices such as handheld devices 30. Images of virtual objects and optionally sounds are made available on the AR capable devices such as the handheld devices 30 as part of an augmented reality game. The images and sound that are made available on the AR capable devices such as the handheld devices 30 depend upon the position and orientation, i.e. pose of the AR capable device such as the handheld device 30. When, in the game, virtual objects move into an area of the arena which is displayed on display 34, then these objects become visible to onlookers.

An example of how the use of display 34 makes the experience more immersive for onlookers, is for instance, if the position of the dragon is as it was in the case of FIG. 6 but the player P is turning its back to the display 34 (and points the handheld device away from the display device 34), the dragon is still displayed on the display device 34. It is therefore visible to onlookers who would happen to look at the display 34 and allow them to enjoy the game (by anticipating what will happen next, or informing the players) even though they do not take part to the game as players. In this situation the server 33 will send gaming instructions back and forth to the AR capable devices such as the handheld devices 30. Images and optionally audio will be generated on the AR capable device such as the handheld device 30 as part of the augmented reality game.

Furthermore, it is possible to use the display device 34 to display a background or element of backgrounds (as e.g. the tree 52 on FIG. 6, or still or animated sceneries in general). Hence, the display device 34 can be used as if it were a window into a virtual world that would otherwise not be visible to onlookers, but would be visible to players equipped with AR capable devices such as handheld devices 30 at the expense however of potentially significant use of storage and computing resources of the AR capable device such as the handheld device 30.

In an example of embodiments, the display device can be used e.g. to display schedules of movies, commercial messages etc. . . . . During the game, images of the virtual objects can be overlaid on those display schedules. Limited element of landscapes (e.g. trees or plants) can also be overlaid on the schedule or commercial messages.

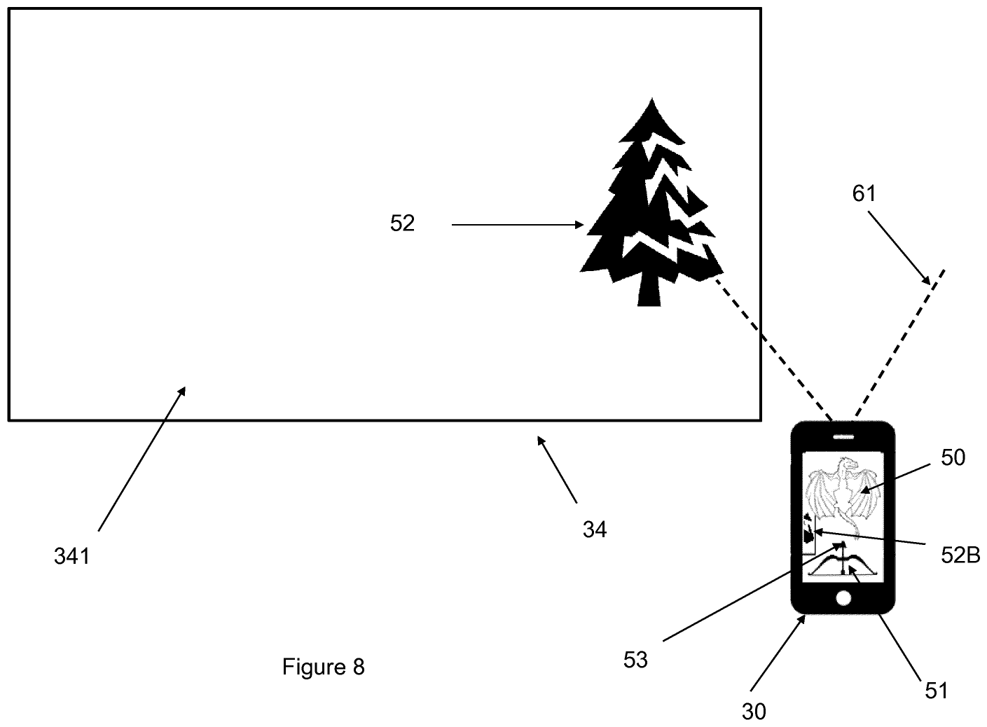

Therefore, embodiments of the present invention provide a solution for improving the immersiveness of the game experience for the players P, as such a window into the virtual world provided by display device 34 can be used as a background to the augmented reality overlay without requiring extra rendering power nor storage space from the AR capable device such as the handheld device 30. FIG. 8 for instance shows how a background (a tree 52) is displayed on the display 34 even though the position of the dragon 50 is such that it is only visible to player P on the AR capable device such as the handheld device 30. Part of the screen 34 is in the field of view 61 of the image sensor or camera 32 and therefore, a part 52B of what is displayed on display 34 as well as an edge of display 34 is captured by the image sensor or camera 32 and displayed on the AR capable device such as the device 30.

In addition to or instead of the display device 34, a 3D sound system can be used to make the augmented reality experience more inclusive of people present in the lobby L while the player P is playing.

In addition to or instead of the display device 34 and/or a 3D sound system, other electronic devices can be used to expand the augmented reality beyond what is made possible by an AR capable device such as a handheld device 30 only. For instance, if the light sources of the lobby are smart appliances (e.g. appliances that can be controlled by the internet protocol), it is possible to vary the intensity. For instance, by decreasing the intensity of a light source or turning it off entirely, one can suggest shadows (as if a dragon flew in front of the light source). By increasing the intensity of the light source (or by turning it back on), one will suggest that the dragon has moved away etc. . . . .

To further engage onlookers present in the lobby, an additional display device 62 can be used to give an overview of the game played by player P. This overview can be a mixed reality view.

For instance, the overview can consist of a view of the 3D model of the lobby (also including real objects like the onlookers and players) wherein virtual objects like the dragon 50 and elements of the virtual background like e.g. the tree 52 are visible as well (at the proper coordinates with respect to the system of reference used in the 3D model). At the same time, the pose of the AR capable device such as the device 30 being known, an icon or more generally a representation of a player P (e.g. a 3D model or an avatar) can be positioned within the 3D model and be displayed on the display device 60.

Alternatively, one or more cameras in the lobby can capture live images of the lobby (including onlookers and player P). The pose of the cameras being known, it is possible to create a virtual camera in the 3D model with the same pose, and generate images with the virtual camera of the virtual objects (dragon, tree, arrows . . . ) and overlay the images of those virtual objects as taken by the virtual cameras to be overlaid on the live images of the lobby on the display device 62. This therefore generates a mixed reality view.

FIG. 9 shows an example of image of the lobby L taken by a camera 200. Some of the elements of the invention are visible: a display device 34, a display device 60 displaying a footprint 40b and a modus operandi 40c and an AR capable device such as a handheld device 30 held by player P.

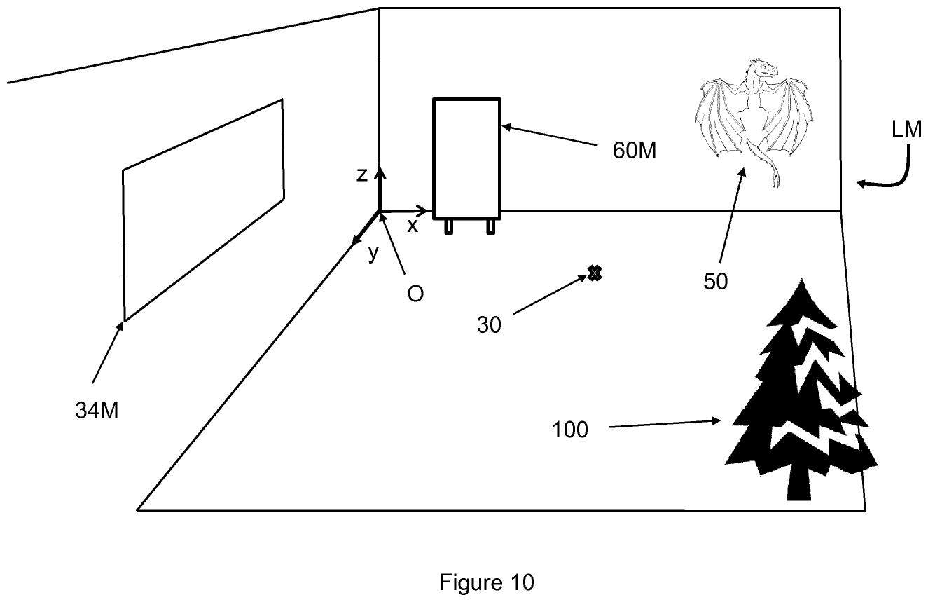

FIG. 10 shows a rendering of the 3D model 37 of the lobby L together with virtual objects like the dragon 50 and a tree 100. The view is taken by a virtual camera that occupies, in the 3D model, the same position as the actual camera in the lobby. Also seen on FIG. 10 are a rendering of the 3D model 34M of the display device 34, and of the 3D model 60M of display device 60. The pose of the AR capable device such as the handheld device 30 is known and the position of the AR capable device such as the handheld device 30 in the 3D model is symbolized by the cross 30M. FIG. 10 shows a possible choice for a coordinate system (threes axes x, y, z and an origin O). If the coordinates of the vertices of the 3D model 60M of display 60 are known, the coordinates of any point on the display surface of display 60 can be mapped to a point on the corresponding surface of the 3D model 60M.

In the example of FIGS. 8, 9 and 10, the display surface of display 60 is parallel to the plane 0xz. The coordinates (x, y, z) of the corners of the display area of display 60 are known in the 3D model and therefore, the position of the footprint 40b displayed on display 60 can be mapped to points in the 3D model.

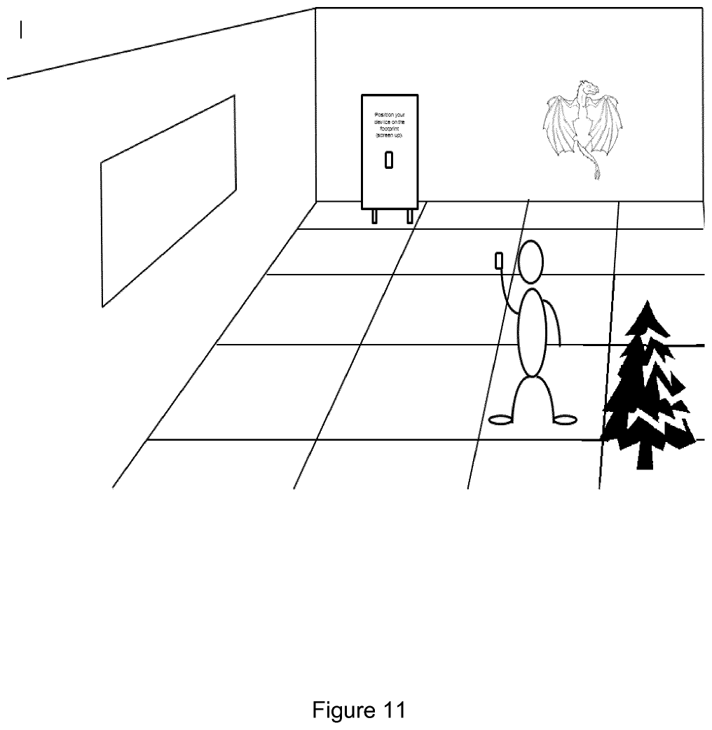

FIG. 11 shows a mash-up of the picture illustrated on FIG. 9 and the rendering of the 3D model illustrated on FIG. 10. It shows virtual objects (dragon and tree) as they would appear from the point of view of a camera 200 and are overlaid on live pictures of the lobby such as a panoramic view i.e. a mixed reality view is created.

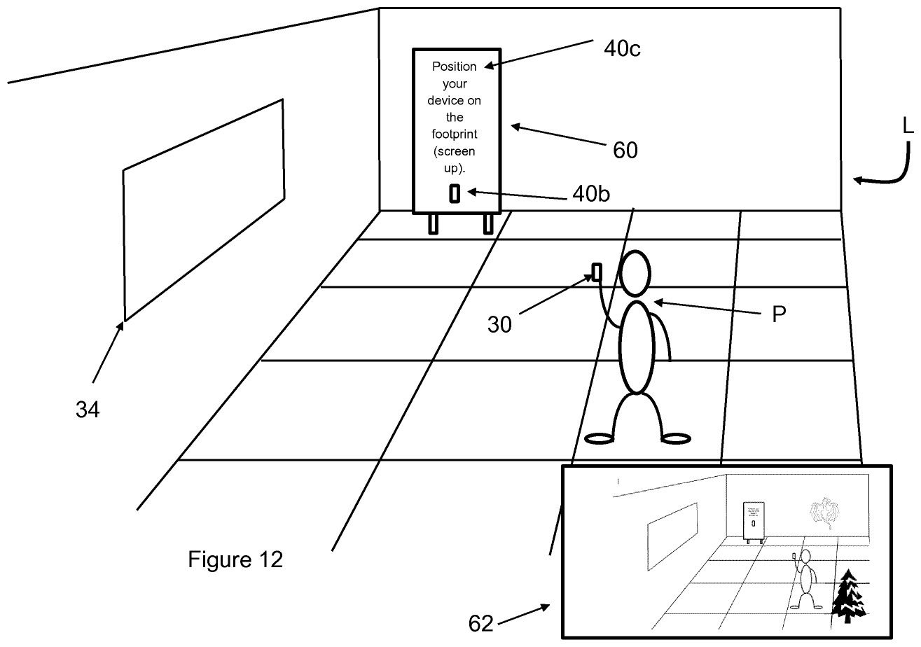

FIG. 12 illustrates the lobby with the display device 62 displaying the mash-up.

The display 62 give onlookers an overview of the game, showing player P and virtual objects and their relative position in the lobby.

The mash-up is displayed on a display 62 (that is not necessarily visible to the camera 200).

The mash-up can be done e.g. on the server 33.

Furthermore, one or more physical video camera(s)—such as webcams or any digital cameras—may be positioned in the lobby L to capture live scenes from the player P playing the Augmented Reality experience. The position and FOV of the camera(s) may be fed to the server 33 so that a virtual camera with same position, orientation and FOV can be associated to each physical camera. Consequently, a geometrically correct mixed reality view can be constructed, consisting in merging both live and virtual feeds from said physical and virtual cameras, and then fed to a display device via either DVI, Display Port or HDMI cables, with or without Ethernet optical fibre extenders 35, or via a streamed internet protocol over a LAN network, so as to provide a mixed reality experience to players as well as onlookers.

Another limitation to Augmented Reality as known from the art is that the amount of visual content that is loaded onto the AR capable devices such as the handheld devices has to be limited to not over drain the computing & rendering capabilities of the AR capable device such as the handheld device 30 nor its storage space nor its battery. This typically results in experiences that only add a few overlays to the camera feed of the AR capable device such as the handheld device 30.

Such an overload can be avoided by taking advantage of existing display devices like 34 and server 33 to provide background elements that need not be generated on the AR capable device such as the handheld device 30 but can be generated on server 33.

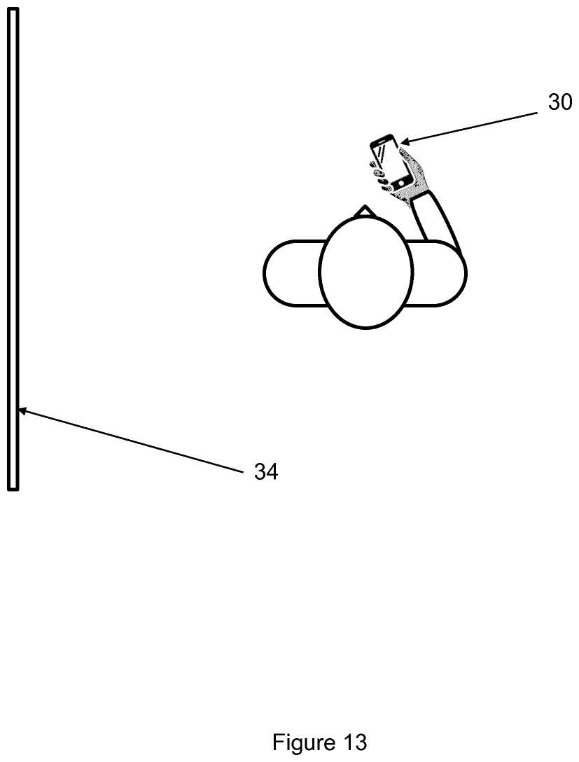

To describe in more details what is displayed on display screen 34, let us take the example of FIG. 13 where the pose of the handheld device 30 is such that the display 34 is out of the field of view of the image sensor or camera 32.

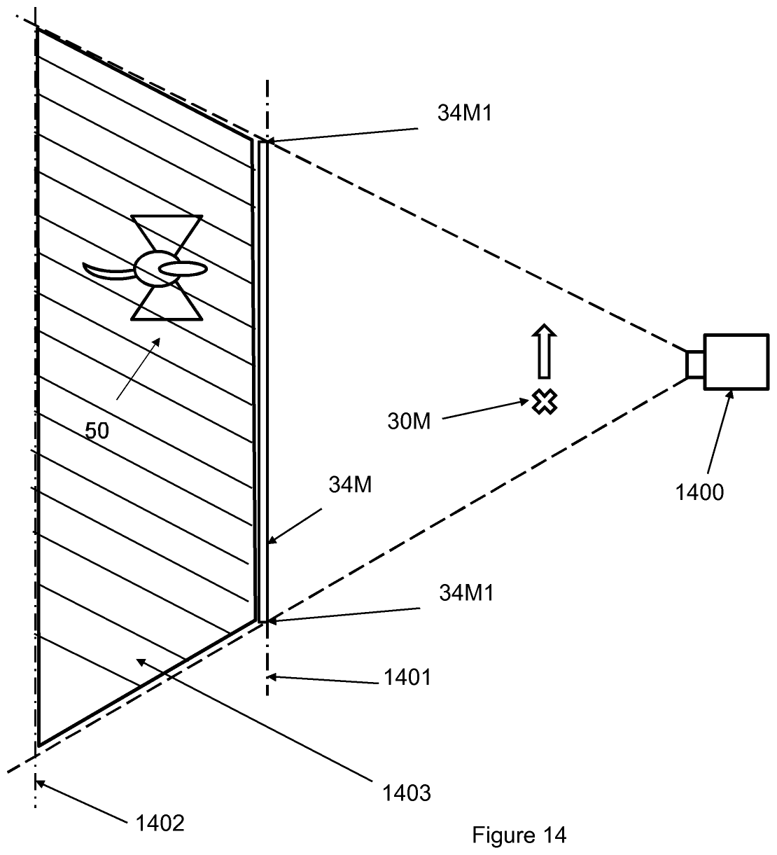

FIG. 14 illustrates a particular moment in the game as it can be represented in the 3D model of the lobby (it corresponds to a top view of the 3D model).

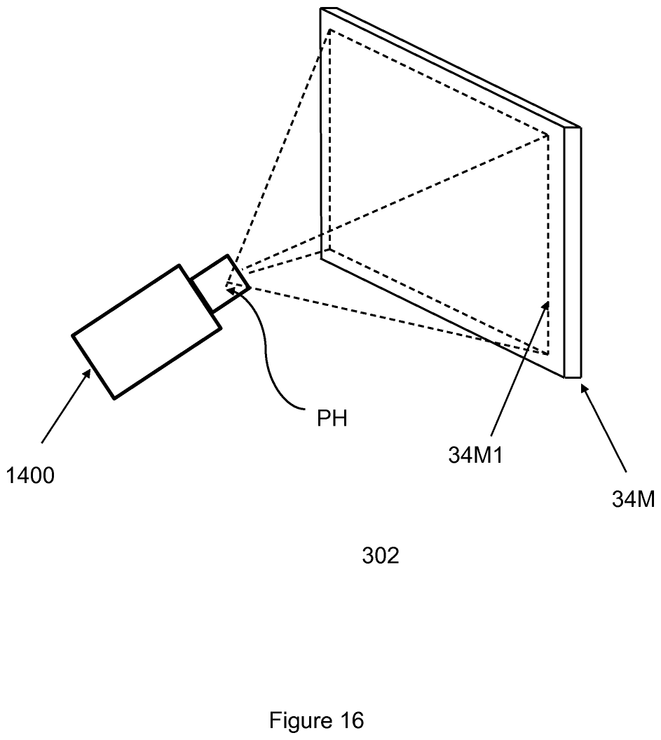

A virtual camera 1400 is defined by the frustum 1403 delimited by the clipping planes 1401 and 1402. We can further determine the frustum 1403 by defining the viewing cone 1404 of the virtual camera 1400. We can use the border 34M1 of the display area of the 3D model 34M of the display 34 as a directrix of the viewing cone and e.g. the pinhole PH of the camera as vertex (if we use a pinhole model for the viewing camera). This is illustrated on FIG. 16.

One of the clipping planes, the near clipping plane, is coplanar with the surface of the 3D model 34M of the display 34 corresponding to the display surface of the display 34.

Virtual objects like e.g. the dragon 50 are displayed or not on the display 34 depending on whether or not these virtual objects are positioned in the viewing frustum 1403 of the virtual camera 1400. This results in the display 34 operating as a window onto the augmented reality arena.

FIG. 14 shows a situation where the dragon 50 is within the frustum 1403. Therefore, a rendering of the dragon is displayed on the display 34.

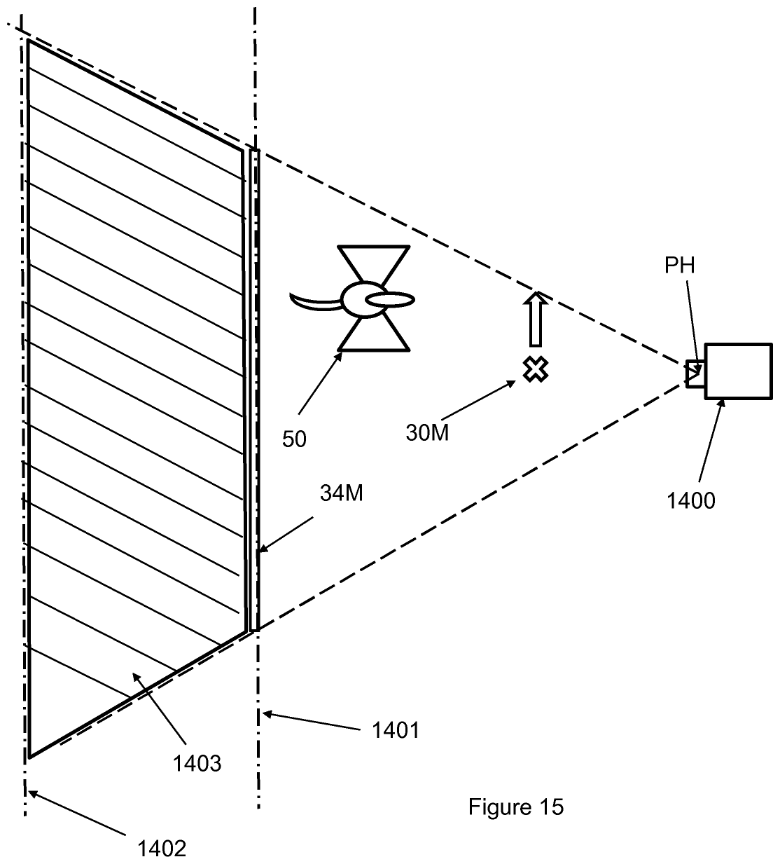

FIG. 15 shows a situation where the dragon 50 is outside of the frustum 1403. Therefore, a rendering of the dragon is not displayed on the display 34. The dragon will only be visible on the AR capable device such as the handheld device 30 if the handheld is oriented properly.

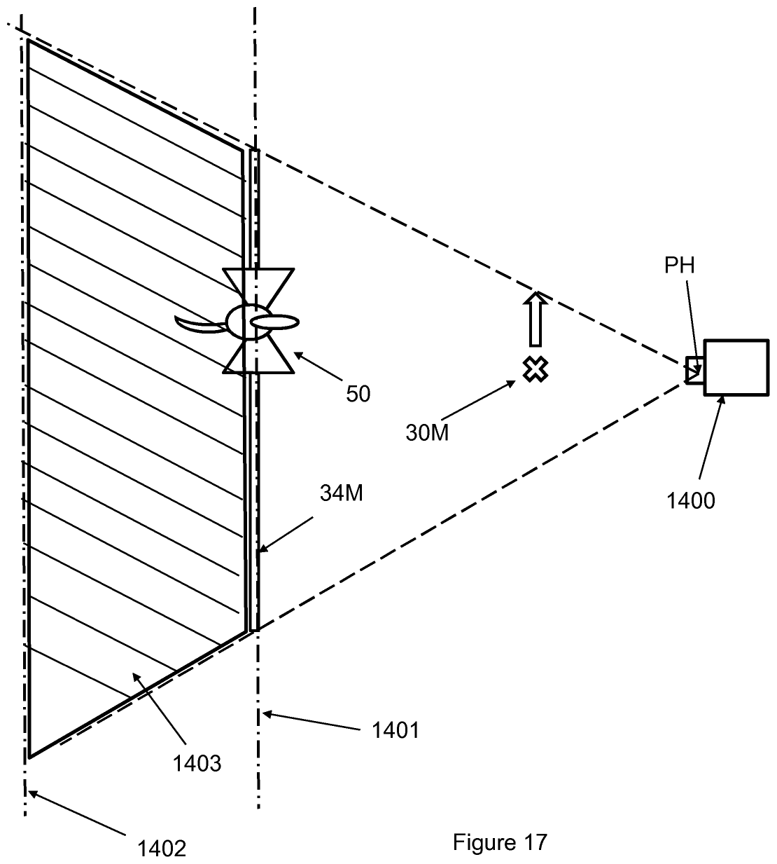

FIG. 17 shows an intermediary case where part of the dragon is in the frustum 1403 and part of the dragon is outside of the frustum. In such a case, one may decide what to display in function of artistic choices or computing limitations. For instance, one may decide to display on the display 34 only the part of the dragon that is inside the frustum. One may decide not to display the dragon at all or only the section of the dragon that is in the near clipping plane. Another example may be to display the dragon in its entirety if more than 50% (e.g. in volume) of the dragon is still in the frustum and not at all if less than 50% is in the frustum. Another solution may be to display the dragon entirely as long as key element of the dragons (like e.g. its head, or a weak spot or “Achille's heal”) is in the frustum.

An advantage of this aspect of the invention is that there is a one-to-one correspondence between the real world (the venue, the display 34 . . . ) and the 3D model. In other words the augmented reality arena coincides with the lobby.

The game designer or the technical personal implementing the augmented reality system according to embodiments of the present invention can easily determine the position (and clipping planes) of the virtual camera based on a 3D model of the venue and the pose (position and orientation) of the display 34. The one-to-one mapping or bijection between a point in the venue and its image in the 3D model simplifies the choice of the clipping plane and frustum that define a virtual camera in the 3D model.

When a decision is taken not to display the dragon on the display 34, then, only a player equipped with a handheld device 30 will be able to see the dragon if the dragon is within the viewing cone of the image sensor or camera 32 associated to the AR capable device such as the handheld device 30.

When (part of) the dragon is displayed on the display 34, then (that part of) the dragon is only displayed on the display 34 even if the dragon is within the field of view of the image sensor or camera 32.

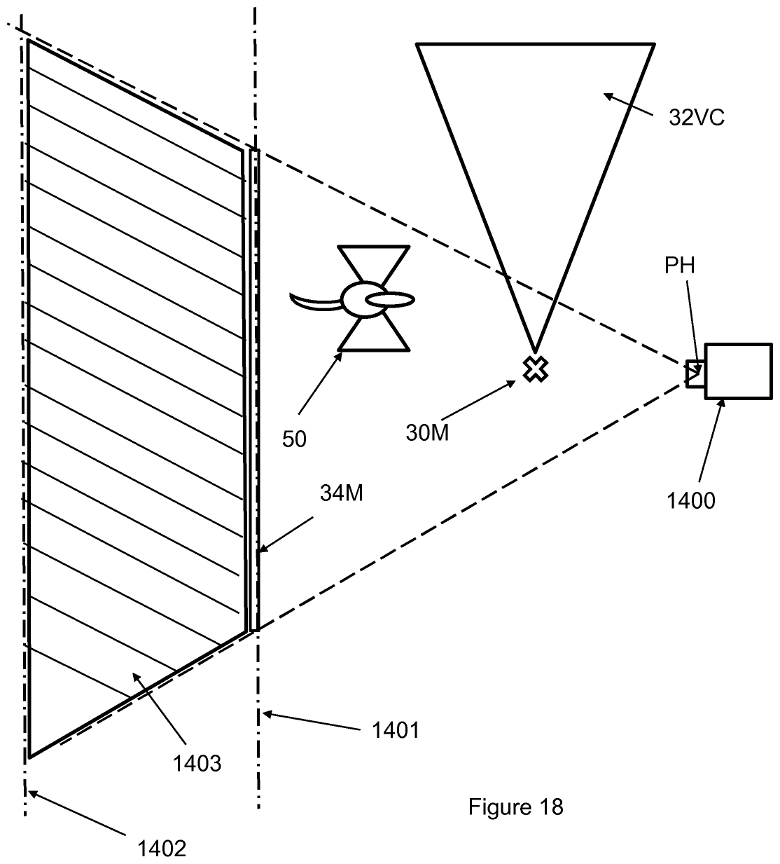

Different relative position and orientations of the display device 34, the handheld device 30 and a virtual object 50 and how this impacts what is displayed on the displays is summarized on FIGS. 18 to 21.

Thanks to the on-to-one mapping of the venue and the 3D model, we can say that e.g. a virtual object is in the viewing cone of a real camera 32 if the position of the virtual object in the 3D model is within region of the 3D model that corresponds to the mapping of the viewing cone in the real world into the 3D model.

We can also discuss the relative position of a real objects w.r.t. a virtual object based on the model or mapping of that object in the 3D model. We can for instance make reference to a handheld device 30 and yet use its representation 30M in the 3D model when discussing the position of a virtual object like the dragon 50 and the handheld device 30.

FIG. 18 shows a situation where the virtual object 50 is outside of the frustum of the virtual camera 1400. The dragon is not displayed on the display device 34.

The position 30M of the handheld device or AR capable device 30 in the 3D model and its orientation are such that the virtual object 50 is not in the viewing cone 32VC of the camera 32 associated with the handheld device 30. The dragon is not displayed on the display device of the handheld device 30.

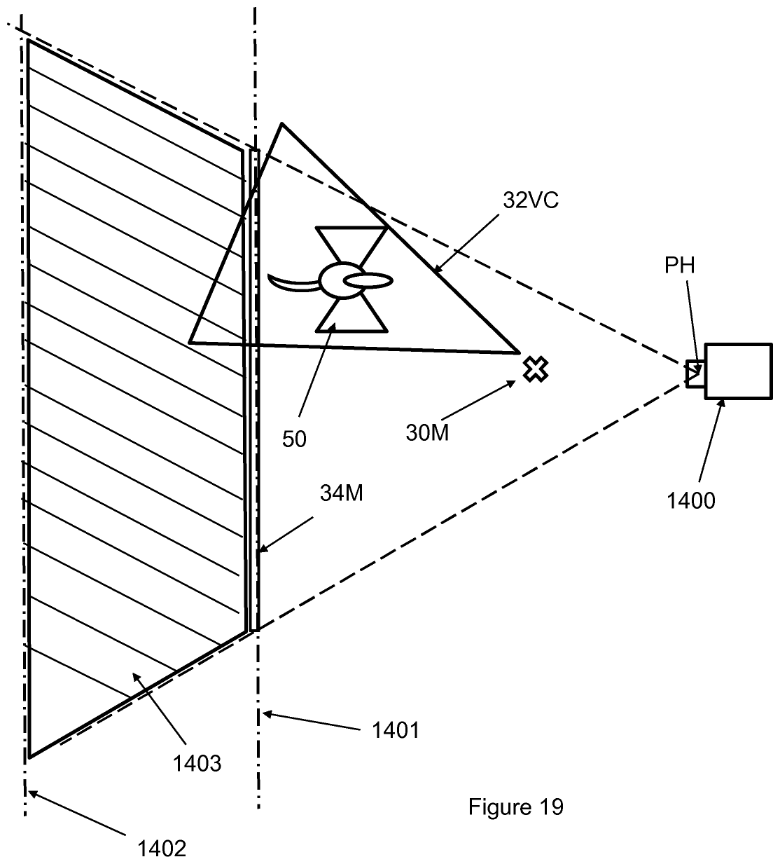

FIG. 19 shows a situation where the virtual object 50 is outside of the frustum of the virtual camera 1400. The dragon is not displayed on display 34. On the other hand, the virtual object is within the viewing cone 32VC of the camera 32 associated with the handheld device 30. The dragon is displayed on the display device of the handheld device 30.

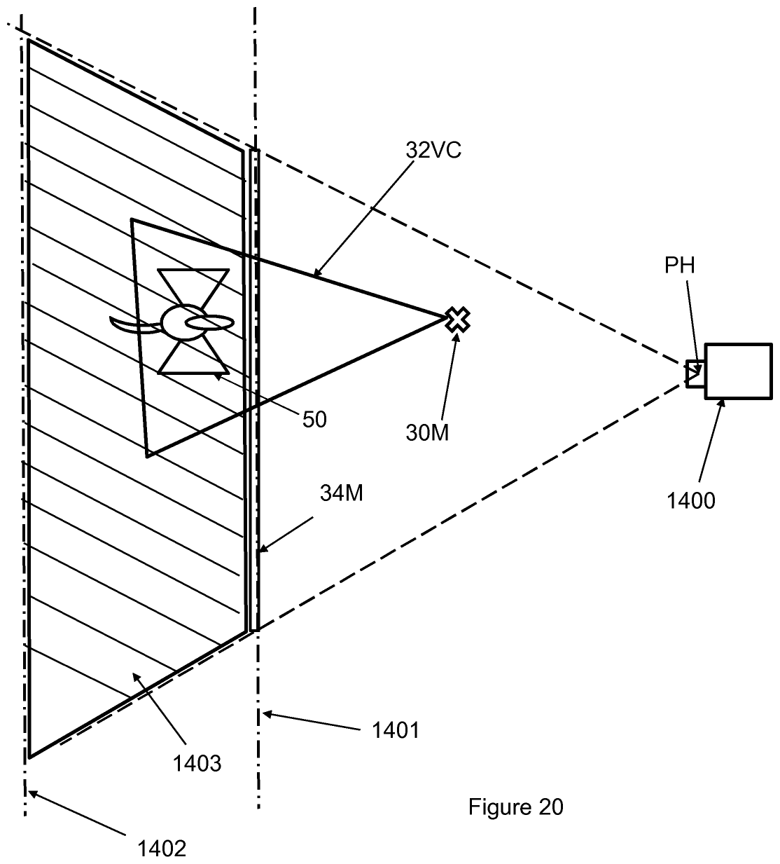

FIG. 20 shows a situation where the virtual object 50 is inside the frustum of virtual camera 1400. The dragon is displayed on the display device 34. Both the virtual object and the display surface of display device 34 are in the viewing cone 32VC of the AR capable device 30. The dragon is not displayed on the display of the handheld device 30. An image of the dragon will be visible on the display of the handheld device 30 by the intermediary of the camera 32 taking pictures of the display area of display 34.

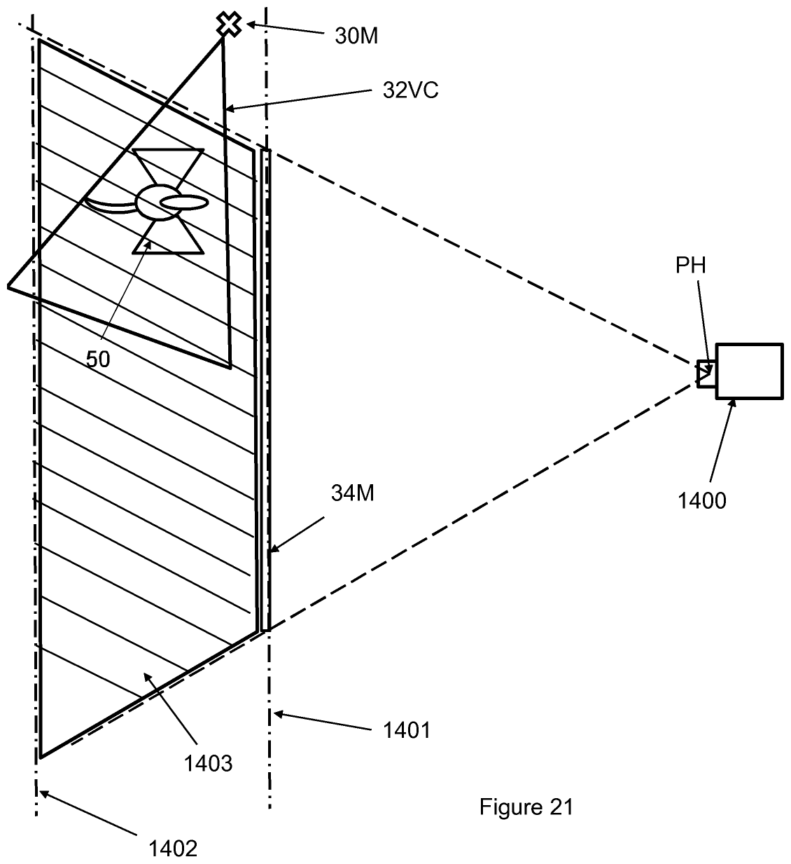

FIG. 21 shows a situation where the virtual object is inside the frustum of virtual camera 1400. The dragon is displayed on the display device 34. The virtual object 50 is in the viewing cone 32VC of the AR capable device 30 but the display surface of display 34 is outside of the viewing cone 32VC of capable device 30. The dragon is also displayed on the display of the AR capable device 30.

The examples show how one decides to display images of a virtual object 50 on the display of handheld device or AR capable device 30 in function of the relative position and orientation of the handheld device 30 and the virtual object as well as a display device 34.

The relative position and orientation of the handheld device and the display device 34 can be evaluated based on the presence or not of the display surface of the display device 34 in the viewing cone of the camera 32 associated with the handheld device 30. Alternatively, one may consider whether or not the camera 32 will be in the viewing angle of the display 34. In both cases, it is the relative position and orientation of the handheld device 30 and display device 34 that will also determine whether or not to display a virtual object on the display of handheld device 30.

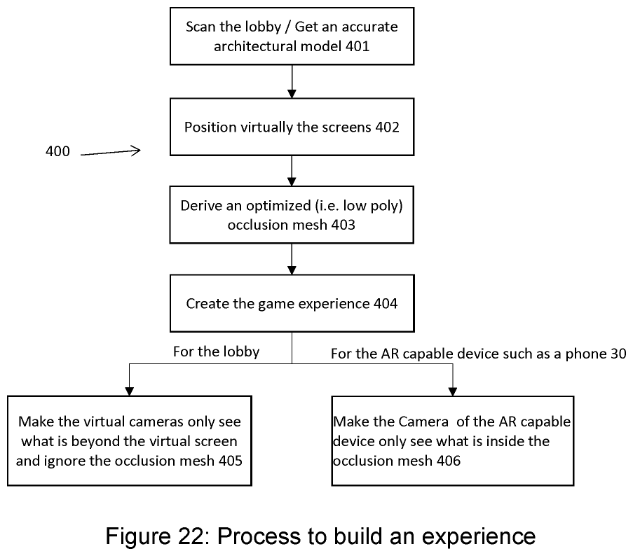

FIG. 22 shows schematically a process 400 by which a lobby game is built. In step 401 the lobby is scanned to obtain an accurate architectural 3D model which will be used with the game to define the physical extent of the game. The architectural 3D model of the venue can be captured from a 3D scanning device or camera or from a multitude of 2D pictures, or created by manual operation using a CAD software.

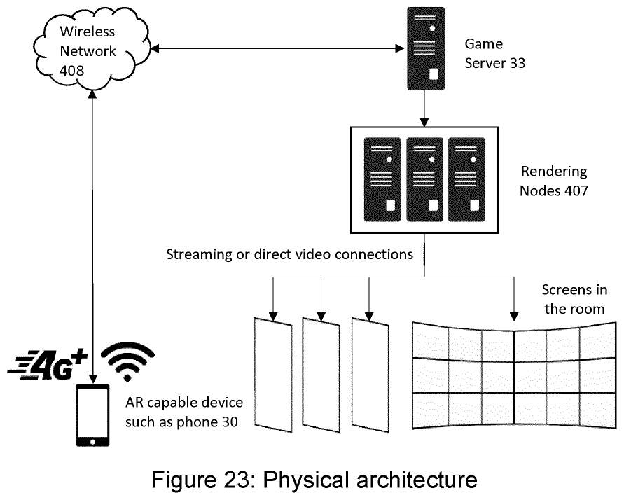

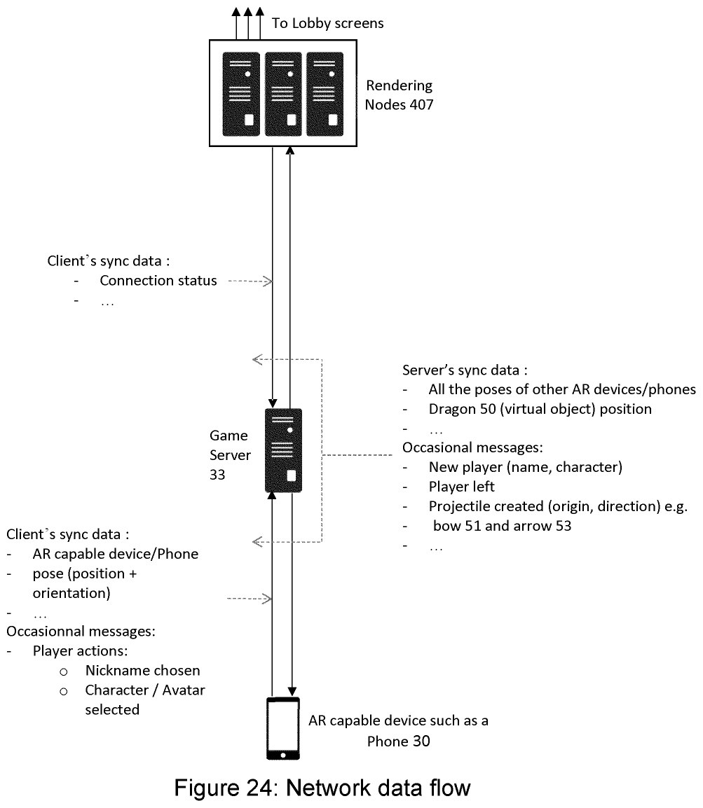

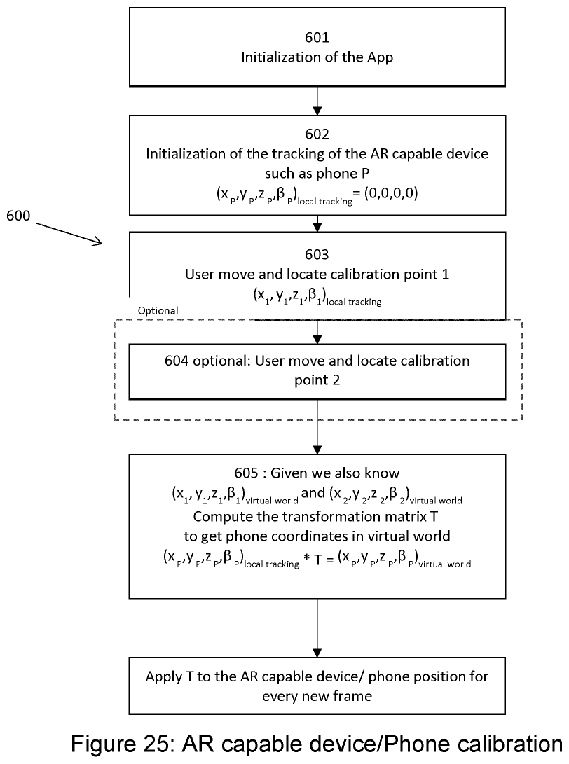

In step 402 various displays or screens as mentioned above which have been placed in the lobby are positioned virtually i.e. in the model of the game. In step 403 an optimized (i.e. low poly) occlusion mesh is generated. This mesh will define what the cameras of the AR capable device can see. Once the occlusion mesh is available the game experience is created in step 404. For the lobby and the AR capable device such as the hand held device 30 e.g. a mobile phone the virtual cameras of the game mentioned above are adapted to only see what is beyond the virtual screen and to ignore the occlusion mesh in step 405. For the AR capable device its camera is adapted to see only what is inside the occlusion mesh in step 406. FIG. 23 shows schematically a physical architecture of a lobby environment including the server 33, various displays and screens in the lobby (mentioned above) that are fed with images, e.g. by streaming or direct video connections from rendering nodes 407 connected to the server 33. The AR capable devices such as handheld devices like mobile phones 30 are connected to the server 33 by means of a wireless network 408. FIG. 24 shows the network flow for the game. The server 33 keeps the information on all the poses of AR capable devices such as hand held devices 30 like phones up to date. As well as the position of the dragon 50 (virtual object). The server 33 can also receive occasional messages such as when a new player enters the game with information like name, character. Another message can be when a player leaves or a new weapon or projectile has been created defined by its origin, and direction e.g. bow 51 and arrow 53. Similar information is available for any other AR capable device referred to in this figure as the “client”. FIG. 25 represents the calibration procedure 600 for each AR capable device such as a hand held device 30 such as a mobile phone. In step 601 applications are initiated. In step 602 the tracking of the AR capable devices such as a hand held device 30 such as a phone (x_{P},y_{P},z_{P}, β_{P})_{local tracking}=(0,0,0,0). In step 603 the user move and locates AR capable device at a first reference calibration point (x₁, y₁, z₁, β₁) for purposes of local tracking. In step 605 the calibration can optionally include a second reference point. In step 606 605: Given that the following is also known (x₁, y₁,z₁, β₁)_{virtual world} and (x₂,y₂,z₂,β₂)_{virtual world} it is possible to compute the transformation matrix T to get AR capable device such as phone 30 coordinates in the virtual world of the game(x_{P},y_{P},z_{P},β_{P})_{local tracking}*T=(x_{P},y_{P},z_{P},β_{P})_{virtual world}. For every step after 606 transform T is applied to the AR capable device/phone position for every new video frame.

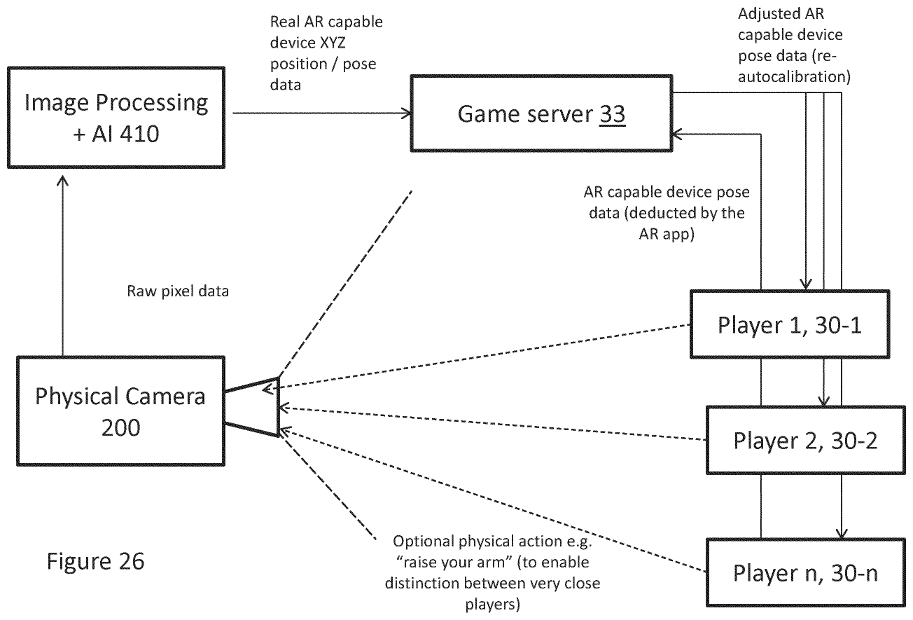

With reference to FIG. 26 the calibration procedure by which the pose as determined by an AR capable device such as a handheld device 30 e.g. a mobile phone is compared to known poses within the lobby can alternatively be done by using the camera 200 taking images of the lobby. FIG. 26 shows a camera 200, the game server 33, various AR capable devices such as a handheld devices 30-1 to 30-n, e.g. mobile phones.

When an AR capable device such as a handheld device 30 e.g. a mobile phone sends pose data to the server 33, that pose data can be used in combination with e.g. image identification software 410 to locate the player holding the AR capable device such as a handheld device 30 e.g. a mobile phone in the lobby on images taken by camera 200. The image identification software 410 can be a computer program product which is executed on a processing engine such as a microprocessor, an FPGA; ASIC etc. This processing engine may be in the server 33 or may be part of a separate device linked to the server 33, and the camera 200. The identification software 410 can supply the AR capable device XYZ position/pose data to the server 33. Alternatively the AR capable device such as the handheld device 30 e.g. a mobile phone can generate pose data deduced by an application running on the AR capable device such as the handheld device 30 e.g. a mobile phone. Alternatively, the AR capable device such as the handheld device 30 e.g. a mobile phone can determine pose data (in an autocalibration procedure).

Calibration can be done routinely or only when triggered by a specific events. For instance, the use of images taken by camera 200 to compare the location of an AR capable device such as a handheld device 30 e.g. a mobile phone as determined by the AR capable device such as a handheld device 30 e.g. a mobile phone with another determination of the pose by analysis of images taken by the camera 200 can be done if and only if the pose data sent by the AR capable device such as a handheld device 30 e.g. a mobile phone corresponds to a well determined position within the lobby. For instance, if the position of the AR capable device such as a handheld device 30 e.g. a mobile phone as determined the device itself indicates that the player should be close to a landmark or milestone within the lobby, the server 33 can be triggered to check whether or not a player is indeed at, near or around the landmark or milestone in the lobby.

The landmark or milestone can be e.g. any feature easily identifiable on images taken by the camera 200. For instance, if a player stands between the landmark or milestone and the camera 200, the landmark or milestone will not be visible anymore on images taken by the camera 200.

Other features of the lobby visible on images taken by camera 200 can be used. For instance, if the floor of the lobby is tiled, the tile will form a grid akin to a 2 dimensional Cartesian system of coordinates. The position of an object on the grid can be determined on images taken by camera 200 by counting tiles or counting seams that exist between adjacent tiles from a reference tile used as reference position on the images taken by camera 200. Alternatively or additionally the participants can be requested to make a user action, e.g. a movement such as hand waving which can be identified by image analysis of images from camera 200 in order to locate the participant in the lobby.

By comparing the position or pose of a player determined by analysis of images taken by camera 200 with the pose data sent by an AR capable device such as a handheld device 30 e.g. a mobile phone, it is possible to e.g. validate the pose data and/or improve the calibration. The validation can be automatic, direct or indirect or by a user action.

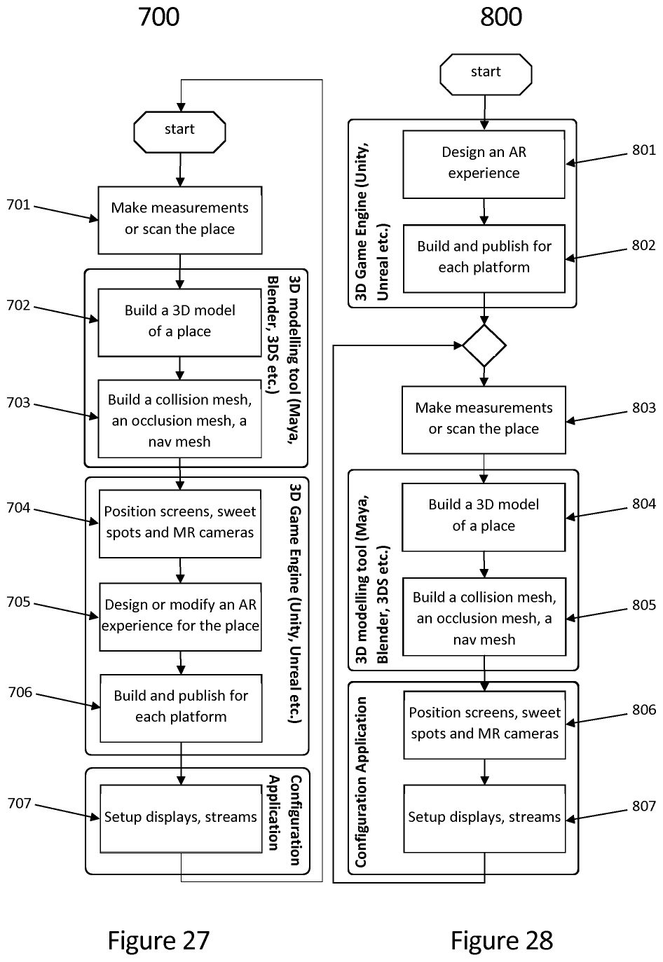

FIG. 27 shows schematically a process 700 by which a lobby game is built. In step 701 the lobby is measured or scanned to obtain an accurate architectural 3D model. The 3D model is built in step 702 and this 3D model will be used with the game to define the physical extent of the game. The architectural 3D model of the venue can be captured from a 3D scan or measurement or created using a CAD software.

In step 703 a collision mesh and/or an occlusion mesh and/or a nav mesh are built. These can be optimized (i.e. low poly) meshes. These meshes will define what the cameras associated to each first and second displays can see. Once the collision, occlusion or nav mesh are available various displays and/or screens and/or cameras and/or sweet spots as mentioned above can be placed in step 704 in the lobby and are positioned virtually i.e. in the 3D model of the game. In step 705 an AR experience can be designed including modifying a previous experience. In step 706 the gaming application can be built and published for each platform, i.e. the game server and the mobile application(s) hosted by the AR capable devices. Finally displays and streams can be set up in step 707.

FIG. 28 shows schematically a process 800 by which a lobby game is built. In step 801 an AR experience can be designed including modifying a previous experience. In step 802 the gaming application can be built and published for each platform.

Consequently or in parallel, in step 803 the lobby is measured or scanned or to obtain by other means an accurate architectural 3D model. The 3D model is built in step 804 and this 3D model will be used with the game to define the physical extent of the game. The architectural 3D model of the venue can be captured from a 3D scan or measurement or created using a CAD software.

In step 805 a collision mesh and/or an occlusion mesh and/or a nav mesh are built. These can be optimized (i.e. low poly) meshes. These meshes will define what the cameras associated to each first and second displays can see. Once the collision, occlusion or nav mesh are available various displays and/or screens and/or cameras and/or sweet spots as mentioned above can be placed in step 806 in the lobby and are positioned virtually i.e. in the 3D model of the game. Finally displays and streams can be set up in step 807.

Methods according to the present invention can be performed by a computer system such as including a sever 33. The present invention can use a processing engine to carry out functions. The processing engine preferably has processing capability such as provided by one or more microprocessors, FPGA's, or a central processing unit (CPU) and/or a Graphics Processing Unit (GPU), and which is adapted to carry out the respective functions by being programmed with software, i.e. one or more computer programs. References to software can encompass any type of programs in any language executable directly or indirectly by a processor, either via a compiled or interpretative language. The implementation of any of the methods of the present invention can be performed by logic circuits, electronic hardware, processors or circuitry which can encompass any kind of logic or analog circuitry, integrated to any degree, and not limited to general purpose processors, digital signal processors, ASICs, FPGAs, discrete components or transistor logic gates and similar.

Such a server 33 may have memory (such as non-transitory computer readable medium, RAM and/or ROM), an operating system, optionally a display such as a fixed format display, ports for data entry devices such as a keyboard, a pointer device such as a “mouse”, serial or parallel ports to communicate other devices, network cards and connections to connect to any of the networks.

The software can be embodied in a computer program product adapted to carry out the functions of any of the methods of the present invention, e.g. as itemised below when the software is loaded onto the server and executed on one or more processing engines such as microprocessors, ASIC's, FPGA's etc. Hence, a server 33 for use with any of the embodiments of the present invention can incorporate a computer system capable of running one or more computer applications in the form of computer software.

The methods described with respect to embodiments of the present invention above can be performed by one or more computer application programs running on the computer system by being loaded into a memory and run on or in association with an operating system such as Windows™ supplied by Microsoft Corp, USA, Linux, Android or similar. The computer system can include a main memory, preferably random access memory (RAM), and may also include a non-transitory hard disk drive and/or a removable non-transitory memory, and/or a non-transitory solid state memory. Non-transitory removable memory can be na optical disk such as a compact disc (CD-ROM or DVD-ROM), a magnetic tape, which is read by and written to by a suitable reader. The removable non-transitory memory can be a computer readable medium having stored therein computer software and/or data. The non-volatile storage memory can be used to store persistent information that should not be lost if the computer system is powered down. The application programs may use and store information in the non-volatile memory.

The software embodied in the computer program product is adapted to carry out the following functions when the software is loaded onto the respective device or devices and executed on one or more processing engines such as microprocessors, ASIC's, FPGA's etc.:

playing an augmented reality game at a venue comprising at least a first display (34), and at least one AR capable device (30) having a second display associated with an image sensor (32).

The software embodied in the computer program product is adapted to carry out the following functions when the software is loaded onto the respective device or devices and executed on one or more processing engines such as microprocessors, ASIC's, FPGA's etc.:

Capturing mages of virtual objects with a virtual camera (1400) of virtual objects for display on the first display device (34);

frustum of the virtual camera is determined by the pinhole (PH) of the virtual camera and the border of the display area of the first display in the 3D model. This further simplifies the generation of images to be displayed on the first display.

The software embodied in the computer program product is adapted to carry out the following functions when the software is loaded onto the respective device or devices and executed on one or more processing engines such as microprocessors, ASIC's, FPGA's etc.:

the near clipping plane of the viewing frustum is adapted to be coplanar with the surface of the 3D model of the first display corresponding to the display surface of the first display;

Operating to decide on which of the first display device or the second display device to render a virtual object.

The software embodied in the computer program product is adapted to carry out the following functions when the software is loaded onto the respective device or devices and executed on one or more processing engines such as microprocessors, ASIC's, FPGA's etc.:

Sending back and forth between the server 33 and the at least one AR capable device game instructions as part of a (hybrid) mixed or augmented reality game;

When 3D models of virtual objects are present in an application running on the at least one AR capable device, images of the game content are rendered on the second display or the first display according to the pose of the AR capable device 30 within a 3D space;

Displaying images on a third display, the images being of the venue and persons playing the game as well as images of a 3D model of the venue and virtual objects. The 3D model of the venue includes a model of the first display and in particular, it includes information on the position of the display surface of the first display device.

The software embodied in the computer program product is adapted to carry out the following functions when the software is loaded onto the respective device or devices and executed on one or more processing engines such as microprocessors, ASIC's, FPGA's etc.:

Using the first display to display images of virtual objects thereby allowing onlookers in the venue to see virtual objects even though they do not have access to an AR capable device;

In the game there are virtual objects and the first display displays a virtual object when the virtual object is in a viewing frustum defined by the field of view of a virtual camera in the 3D model;

The viewing frustum can be further defined by a clipping plane of which the position and orientation are the same as the position and orientation of the display surface of the first display device in the 3D model.

The software embodied in the computer program product is adapted to carry out the following functions when the software is loaded onto the respective device or devices and executed on one or more processing engines such as microprocessors, ASIC's, FPGA's etc.:

Generating a 2D representation of a 3D scene inside the viewing frustum by a perspective projection of the points in the viewing frustum onto an image plane, whereby the image plane for projection can be the near clipping plane of the viewing frustum;

When an image sensor of the AR capable device is directed towards the first display, images of virtual objects are displayed on the first display rather than on the second display,

The software embodied in the computer program product is adapted to carry out the following functions when the software is loaded onto the respective device or devices and executed on one or more processing engines such as microprocessors, ASIC's, FPGA's etc.:

playing a (hybrid) mixed or augmented reality game at a venue comprising at least a first display (34), and at least one AR capable device (30) having a second display associated with an image sensor (32), the method comprising:
running a gaming application on the at least one AR capable device, the method being characterized in that the images of virtual objects displayed on the second display are function of a relative position and orientation of the AR capable device with respect to both the first display and the virtual objects.

The software embodied in the computer program product is adapted to carry out the following functions when the software is loaded onto the respective device or devices and executed on one or more processing engines such as microprocessors, ASIC's, FPGA's etc.: comprising the step of generating images for display on the first display by means of a 3D camera in a 3D model of the venue;

the display device on which a virtual object is rendered depends on the position of a virtual object with respect to the virtual camera;
a virtual object is rendered on the first display if the virtual object is within a viewing frustum of the virtual camera, whereby the computational steps to render that 3D object are not carried out on an AR capable device but on another processor like e.g. the server 33 thereby increasing the power autonomy of the AR capable device.

The software embodied in the computer program product is adapted to carry out the following functions when the software is loaded onto the respective device or devices and executed on one or more processing engines such as microprocessors, ASIC's, FPGA's etc.:

Objects not rendered by a handheld device can nevertheless be visible on that AR capable device through image capture by the camera of the AR capable device when the first display is in the viewing cone of the camera;

a virtual object that is being rendered on the first display device can nevertheless be rendered on an AR capable device if the display surface is not in the viewing cone of the camera of that AR capable device and the virtual object is in the viewing cone of the camera of that AR capable device.

The software embodied in the computer program product is adapted to carry out the following functions when the software is loaded onto the respective device or devices and executed on one or more processing engines such as microprocessors, ASIC's, FPGA's etc.:

running a gaming application on the at least one AR capable device,
images of virtual objects displayed on the second display are a function of a relative position and orientation of the AR capable device with respect to both the first display and the virtual objects.

The software embodied in the computer program product is adapted to carry out the following functions when the software is loaded onto the respective device or devices and executed on one or more processing engines such as microprocessors, ASIC's, FPGA's etc.:

operating a (hybrid) mixed or augmented reality system for playing a (hybrid) mixed or augmented reality game at a lobby comprising at least a first display (34), and at least one AR capable device (30) having a second display (31),
a calibrating of the position and/or the pose of the AR capable device with that of other objects by comparing the pose of the AR capable device with a predetermined pose or reference pose within the lobby, or a position or pose of an AR capable device is determined by analysis of images taken by a camera with pose data from an AR capable device;
calibrating comprising positioning the AR capable device at a known distance from a distinctive pattern;
the calibrating including the AR capable device being positioned so that an image of the distinctive pattern is more or less centered on a display area of the AR capable device, i.e. the image appears visibly on the display area of the AR capable device.

The software embodied in the computer program product is adapted to carry out the following functions when the software is loaded onto the respective device or devices and executed on one or more processing engines such as microprocessors, ASIC's, FPGA's etc.:

when the AR capable device is positioned, the pose data is validated;
once validated, the pose data associated with a first reference point in the lobby is stored on the AR capable device or is sent to a server together with an identifier to associate that data to the particular AR capable device;
a second reference point different from the first reference point can be used or a plurality of such reference points could be used.

Validation by user action, e.g. he player can validate pose data by e.g. pressing a key of the AR capable device or by touching the touchscreen at a position indicated on the touchscreen by the application.

In another embodiment, software is embodied in a computer program product adapted to carry out the following functions when the software is loaded onto the respective device or devices and executed on one or more processing engines such as microprocessors, ASIC's, FPGA's etc.:

providing a mixed or augmented reality game at a venue, having an architectural 3D model of the venue, and at least a first display (34), and at least one AR capable device (30) having a second display (31) associated with an image sensor (32),
the at least first display can be a non-AR capable display,
displaying of images on any of the first and second displays is dependent on their respective position and orientation within the architectural 3D model of the venue.

The software embodied in the computer program product is adapted to carry out the following functions when the software is loaded onto the respective device or devices and executed on one or more processing engines such as microprocessors, ASIC's, FPGA's etc.: fixing of the position and orientation of the at least one first display in space and represented within the 3D model of the venue,

the position and orientation of the at least one AR capable device being not fixed in space,
the position and orientation of the at least one AR capable device being updated in real time within the 3D model with respect to its position and orientation in the real space.

The software embodied in the computer program product is adapted to carry out the following functions when the software is loaded onto the respective device or devices and executed on one or more processing engines such as microprocessors, ASIC's, FPGA's etc.: the 3D architectural model of the venue is augmented and populated with virtual objects in a game computer program,

the game computer program containing virtual objects is augmented with the 3D architectural model of the venue, or elements from it,
the 3D architectural model of the venue may only consist in the 3D model of the first display.

The software embodied in the computer program product is adapted to carry out the following functions when the software is loaded onto the respective device or devices and executed on one or more processing engines such as microprocessors, ASIC's, FPGA's etc.:

the position and trajectory of virtual objects within the game computer program is determined according to the size, pixel resolution, number, position and orientation of the first display(s) and/or other architectural features of the 3D model,
the position and trajectory of virtual objects within the game computer program are determined according to the position and orientation of the at least one AR capable device,
the position and trajectory of virtual objects within the game computer program are determined according to a number of AR capable devices present in the venue and running the game application associated to the game computer program,
the position and trajectory of virtual objects within the game computer program are determined according to the position, orientation and field of view of one or more physical camera(s) present in the venue.

The software embodied in the computer program product is adapted to carry out the following functions when the software is loaded onto the respective device or devices and executed on one or more processing engines such as microprocessors, ASIC's, FPGA's etc.: the architectural 3D model of the venue is captured from a 3D scanning device or camera or from a plurality of 2D pictures, or created by manual operation using a CAD software,

each fixed display has a virtual volume in front of or behind the display having one side coplanar with its display surface,
a virtual volume is programmed in a game application as either a visibility volume or a non-visibility volume with respect a given virtual object, for the AR capable device.

The software embodied in the computer program product is adapted to carry out the following functions when the software is loaded onto the respective device or devices and executed on one or more processing engines such as microprocessors, ASIC's, FPGA's etc.:

spatial registration of the at least one AR capable device within the architectural 3D model of the venue is achieved by a recognition and geometric registration algorithm of a pre-defined pattern or of a physical reference point present in the venue and spatially registered in the architectural 3D model of the venue,
a registration pattern may be displayed by the game computer program on one first display with the pixel coordinates of the pattern being defined in the game computer program,
a plurality of different registration patterns displayed on the multitude of first displays, pixel coordinates of each pattern, respectively, being defined in the game computer program,
spatial registration of the at least one AR capable device is achieved and/or further refined by image analysis of images captured by one or multiple cameras present in the venue where said AR capable device is being operated.

The software embodied in the computer program product is adapted to carry out the following functions when the software is loaded onto the respective device or devices and executed on one or more processing engines such as microprocessors, ASIC's, FPGA's etc.:

the AR capable device runs a gaming application.

Any of the above software may be implemented as a computer program product which has

been compiled for a processing engine in any of the servers or nodes of the network. The computer program product may be stored on a non-transitory signal storage medium such as an optical disk (CD-ROM or DVD-ROM), a digital magnetic tape, a magnetic disk, a solid state memory such as a USB flash memory, a ROM, etc.

1-70. (canceled)

71. A mixed or augmented reality system for providing a mixed or augmented reality game at a venue, having an architectural 3D model of the venue, the system comprising:
at least a first display, and
at least one AR capable device having a second display associated with an image sensor,
wherein display of images on any of the first and second displays depends on their respective position and orientation within the architectural 3D model of the venue,
wherein the 3D architectural model of the venue is augmented and populated with virtual objects in a game computer program.

72. The mixed or augmented reality system according to claim 71, wherein the 3D architectural model of the venue only consists in the 3D model of at least the first display, or of a portion of the at least first display.

73. The mixed or augmented reality system according to claim 71, wherein the position and trajectory of virtual objects within the game computer program are determined according to any of, or any combination of the size, pixel resolution, number, position and orientation of the first display(s) and/or other architectural features of the 3D model.

74. The mixed or augmented reality system according to claim 71, wherein spatial registration of the at least one AR capable device within the architectural 3D model of the venue is achieved by a recognition and geometric registration algorithm of a pre-defined pattern or of a physical reference point present in the venue and spatially registered in the architectural 3D model of the venue.

75. The mixed or augmented reality system according to claim 74, wherein one or more registration pattern(s) may be displayed by the game computer program on one first display with the size and pixel coordinates of the pattern(s) being defined in the game computer program.

76. The mixed or augmented reality system according to claim 75, wherein there are a plurality of different registration patterns displayed on the multitude of first displays, the size and pixel coordinates of each pattern, respectively, being defined in the game computer program.

77. The mixed or augmented reality system according to claim 71, further comprising a calibration wherein one or more predetermined poses or reference poses within the lobby are provided to compare the position and/or the pose of the AR capable device with that of other objects or a position or pose of an AR capable device is determined by analysis of images taken by a camera with pose data from an AR capable device.

78. A method of providing a mixed or augmented reality game at a venue, having an architectural 3D model of the venue, and at least a first display, and at least one AR capable device having a second display associated with an image sensor, wherein displaying of images on any of the first and second displays depends on their respective position and orientation within the architectural 3D model of the venue, wherein the 3D architectural model of the venue is augmented and populated with virtual objects in a game computer program.

79. The method according to claim 78, wherein the position and trajectory of virtual objects within the game computer program are determined according to any of, or any combination of the size, pixel resolution, number, position and orientation of the first display(s) and/or other architectural features of the 3D model.

80. The method according to claim 78, wherein spatial registration of the at least one AR capable device within the architectural 3D model of the venue is achieved by a recognition and geometric registration algorithm of one or more pre-defined pattern(s) or physical reference point(s) present in the venue and spatially registered in the architectural 3D model of the venue.

81. The method according to claim 78, the method comprising:
running a gaming application on the at least one AR capable device and on a game server connected to the at least first display,
wherein the images of virtual objects displayed on the second display are a function of a relative position and orientation of the AR capable device with respect to both the first display, and the virtual objects.

82. A non-transitory signal storage element storing a computer program product which when executed on a processor executes the method steps of claim 78.

83. A mixed or augmented reality system for playing an mixed or augmented reality game at a venue, characterized by a 3D model, and comprising:
at least a first non-AR capable fixed display, and
at least one AR capable device having a second display associated with an image sensor, the AR capable device running a gaming application featuring virtual objects,
wherein rendering of images on the AR capable device depends on a relative position and orientation of the AR capable device with respect to both the at least first display and virtual objects,
wherein a virtual camera within the game application program captures images of virtual objects for display on the first display device or on a portion of it.

84. The augmented reality system according to claim 83, wherein the frustum of the virtual camera is determined by any of or any combination of the pinhole (PH) of the virtual camera and the border of the display area, and of a portion of the display area, and of any surface encompassing the display area, of the first display in the 3D model.

85. The augmented reality system according to claim 84, wherein the position of the pinhole of the virtual camera may be determined in relation to the position and orientation of the first display(s) and/or to physical elements of the venue.

86. The augmented reality system according to claim 85, wherein the near clipping plane of the viewing frustum is coplanar with the surface of the 3D model of the first display corresponding to the display surface of the first display or with the display surface of the first display in the 3D model.

87. The augmented reality system according to claim 83, further comprising a server wherein game instructions are sent back and forth between the server and the at least one AR capable device as part of a mixed or augmented reality game, all the 3D models of virtual objects being present in an application running on the at least one AR capable devices and images of the virtual objects are rendered on the second display according to the pose of the at least one AR capable device 30 within a 3D space.

88. The augmented reality system according to claim 84, wherein there are virtual objects in the augmented reality game and the first display displays a virtual object when the virtual object is in a viewing frustum of the virtual camera.

89. The augmented reality system according to claim 83, wherein images of the venue and persons playing the game as well as images of virtual object and or a model of the venue are displayed on a third display, or on a portion of the first display.

90. The augmented reality system according to claim 83, wherein an image sensor is directed towards the first display displaying a virtual object, the virtual object is not rendered on the AR capable device but is visible on the second display as part of an image captured by the image sensor.
